(19) United States
(12) Patent Application Publication
(10) Pub. No.: US 2026/0127740 A1
(43) Pub. Date: May 7, 2026

(54) METHOD AND APPARATUS FOR GENERATING LESION MODEL OF TARGET SITE

(71) Applicant: Shenzhen Mindray Bio-Medical Electronics Co., Ltd., Shenzhen (CN)

(72) Inventors: Zixuan CHEN, Shenzhen (CN); Muqing LIN, Shenzhen (CN); Yaoxian ZOU, Shenzhen (CN)

(21) Appl. No.: 19/437,020

(22) Filed: Dec. 30, 2025

(30) Foreign Application Priority Data
Apr. 7, 2024 (CN) 202410410533.0

(51) Int. Cl. G06T 7/00; G06T 7/73

(52) U.S. Cl. CPC G06T 7/0012; G06T 7/75; G06T 2207/10132; G06T 2207/30048; G06T 2207/30096

(57) ABSTRACT

Disclosed are a method and apparatus for generating a lesion model of a tissue site, and a computer-readable storage medium. The method includes obtaining a determined lesion type of the tissue site, determining a plurality of determined sub-anatomical models from a model database of the tissue site based on the obtained determined lesion type, generating a lesion model of the tissue site based on the plurality of determined sub-anatomical models, and displaying the lesion model of the tissue site. Accordingly, the lesion model of the lesion type corresponding to the tissue site can be generated as disclosed herein.

### CROSS-REFERENCE TO RELATED APPLICATIONS

This application claims priority to Chinese Patent Application 202410410533.0, entitled “METHOD AND APPARATUS FOR GENERATING A LESION MODEL OF A TARGET SITE” filed with the China National Intellectual Property Administration on Apr. 7, 2024, all of which are incorporated herein by reference in their entirety.

### TECHNICAL FIELD

The present disclosure relates to the field of medical engineering, in particular to methods and apparatus for generating a lesion model of a target site.

### BACKGROUND OF THE DISCLOSURE

In real clinical practice, many patients exhibit complex diseases that do not conform to the simplified representations found in textbooks. These diseases often involve multiple lesions and exhibit diverse manifestations. A common example is congenital heart disease, which encompasses both single conditions and complex malformations, spanning a wide range of over a hundred specific subtypes and potentially including multiple malformations

Multidisciplinary Team (MDT) consultations are recognized as the most effective way to treat complex diseases. However, due to the fact that medical reports are mostly descriptive text, the descriptions of complex diseases are obscure and difficult to comprehend, making it challenging for doctors to accurately depict the specific details of lesions or malformations in relation to clinical anatomy. In addition, patients frequently lack sufficient clinical knowledge and proper guidance, leading to anxiety and misunderstanding regarding complex diseases. These factors often contribute to ineffective MDT communication, potentially resulting in misdiagnosis.

### SUMMARY OF THE DISCLOSURE

The present disclosure provides methods and apparatus for generating a lesion model of a tissue site, which will be specifically described below.

In an embodiment, a method for generating a lesion model of a tissue site is provided, which may include:
obtaining an ultrasound data of the tissue site;
displaying a lesion type selection interface for the tissue site;
determining a determined lesion type of the tissue site in response to an operation on the lesion type selection interface according to the ultrasound data;
based on the determined lesion type of the tissue site, determining, from a model database of the tissue site, a plurality of determined sub-anatomical models corresponding to the determined lesion type;
generating a lesion model of the tissue site based on the plurality of determined sub-anatomical models; and
displaying the lesion model of the tissue site.

In an embodiment, the model database of the tissue site may include a plurality of sub-anatomical models. The plurality of sub-anatomical models may include a category of general sub-anatomical model configured to define a complete anatomical structure of the tissue site. At least one of the category of general sub-anatomical model may include a plurality of general sub-anatomical models that are identical in category but different in morphology and are configured to distinguish lesion types of the tissue site. Alternatively, the plurality of sub-anatomical models may further include a category of special sub-anatomical model configured to distinguishing the lesion types of the tissue site.

In an embodiment, the tissue site may include a fetal heart or a heart. The category of general sub-anatomical model may include a model of at least one of a chamber, a myocardial tissue, an arterial blood vessel, a valve and a venous blood vessel. The category of special sub-anatomical model may include a model of at least one of a defect, a foramen ovale and a tumor.

In an embodiment, the tissue site may include a blood vessel. The category of general sub-anatomical model may include a model of at least one of a coronary artery, a carotid artery, an abdominal aorta and a superficial vein. The category of special sub-anatomical model may include a model of at least one of a plaque, and aneurysm and an embolism.

In an embodiment, generating the lesion model of the tissue site based on the plurality of determined sub-anatomical models may include: superimposing the plurality of determined sub-anatomical models in a predetermined order to generate the lesion model.

In an embodiment, the method in any one of the embodiments above may further include: in response to an edit command for the displayed lesion model, editing the lesion model.

In an embodiment, said editing the lesion model may include at least one of:
adding one or more sub-anatomical models to the lesion model;
deleting one or more sub-anatomical models contained in the lesion model; and
editing a morphology and/or a position of one or more sub-anatomical models contained in the lesion model.

In an embodiment, the tissue site may include a fetal heart or a heart, and adding one or more sub-anatomical models to the lesion model may include at least one of: adding a vascular branch to the lesion model; adding a bridging vessel to the lesion model; adding a tumor to the lesion model; and adding a defect to the lesion model.

In an embodiment, the tissue site may include a fetal heart or a heart; and editing morphology and/or position of one or more sub-anatomical models contained in the lesion model may include at least one of: editing a thickness of an entire vessel or a local vessel in the lesion model; editing a size, position, and/or direction of a tumor in the lesion model; editing a size of an atrium or a ventricle in the lesion model; editing a wall thickness of an atrium or a ventricle in the lesion model; editing a size of an arterial valve in the lesion model; editing an opening size of a mitral valve or a tricuspid valve in the lesion model; editing a thickness of a mitral valve or a tricuspid valve in the lesion model; editing a thickness of an arterial cone in the lesion model; and editing a superimposing order of the sub-anatomical models in the lesion model.

In an embodiment, the method in any one of the embodiments above may further include:
determining a sub-anatomical model desired to be highlighted in the displayed lesion model; and
highlighting the determined sub-anatomical model.

In an embodiment, a method for generating a lesion model of a tissue site is provided, which may include:
obtaining a determined lesion type of the tissue site;
based on the determined lesion type of the tissue site, determining a plurality of determined sub-anatomical models from a model database of the tissue site;
generating a lesion model of the tissue site based on the plurality of determined sub-anatomical models; and
displaying the lesion model of the tissue site.

In an embodiment, obtaining the determined lesion type of the tissue site may include:
displaying a lesion type selection interface for the tissue site; and
determining the determined lesion type of the tissue site in response to an operation on the lesion type selection interface.

In an embodiment, obtaining the determined lesion type of the tissue site may include:
obtaining an ultrasound data of the tissue site; and
automatically recognizing the determined lesion type of the tissue site based on the ultrasound data of the tissue site.

In any one of the embodiments above, the model database of the tissue site may include a plurality of sub-anatomical models; the plurality of sub-anatomical models may include at least one category of general sub-anatomical model configured to define a complete anatomical structure of the tissue site; the at least one category of general sub-anatomical model may include a plurality of general sub-anatomical models that are identical in category but different in morphology and are configured to distinguishing lesion types of the tissue site. Alternatively, the plurality of sub-anatomical models may include at least one category of special sub-anatomical model configured to distinguishing the lesion types of the tissue site.

The method of any one of the embodiments above may further include: in response to an edit command for the displayed lesion model, editing the lesion model.

In any one of the embodiments above, in the generated lesion model, at least two of the plurality of determined sub-anatomical models are located on different layers.

In an embodiment, a method for generating a lesion model of a tissue site is provided, which may include:
providing a user interface, where the user interface may include a control pointing to a lesion model generation mode;
receiving an operation to the control in the user interface; and
in response to the operation to the control in the user interface, entering a lesion model generation mode;
wherein, in the lesion model generation mode:
displaying a lesion type selection interface for the tissue site;
receiving a first selection operation on the lesion type selection interface;
in response to the first selection operation on the lesion type selection interface, determining a determined total lesion type from one or more total lesion types in the lesion type selection interface;
displaying one or more sub-lesion types corresponding to the determined total lesion type, wherein the one or more sub-lesion types corresponding to the determined total lesion type are sub-lesion types belonging to the determined total target lesion type;
receiving a second selection operation for the displayed one or more sub-lesion types;
in response to the second selection operation, determining a determined lesion type from the displayed one or more sub-lesion types;
generating a lesion model of the tissue site according to the determined lesion type; and
displaying the lesion model of the tissue site.

In an embodiment, a method for generating a lesion model of a tissue site is provided, which may include:
providing a user interface, wherein the user interface may include a control pointing to a lesion model generation mode;
receiving an operation to the control on the user interface; and
in response to the operation to the control on the user interface, entering a lesion model generation mode;
wherein, in the lesion model generation mode:
displaying a lesion type selection interface for the tissue site, wherein the lesion type selection interface may include one or more lesion types;
in response to an operation on the lesion type selection interface, determining a determined lesion type of the tissue site from the one or more lesion types in the lesion type selection interface;
generating a lesion model of the tissue site based on the determined lesion type; and
displaying the lesion model of the tissue site.

In any one of the embodiments above, the generated lesion model may include a plurality of sub-anatomical models, where at least two of the plurality of sub-anatomical models of the lesion model are located in different layers of the lesion model.

In an embodiment, the method may further include:
determining a sub-anatomical model desired to be highlighted in the displayed lesion model; and
highlighting the determined sub-anatomical model.

In an embodiment, the method may further include: editing the lesion model in response to an editing command to the displayed lesion model.

In any one of the embodiments above, the lesion model may include a vascular model, and the method may further include:
determining a first position at the vascular model of the lesion model;
according to the determined first position, adding a vascular branch model at the first position of the lesion model;
or,
determining a first position at the vascular model of the lesion model;
determining a second position at the vascular model of the lesion model; and
according to the determined first position and the determined second position, adding a bridging vascular model connecting the first position and the second position to the lesion model.

In any one of the embodiments above, the lesion model may include a fetal heart model or a heart model, and the method may further include:
determining a position for new defect in the fetal heart model or the heart model of the lesion model; and
adding a ventricular septal defect model, an atrial septal defect model and/or an atrioventricular septal defect model at the position for new defect in the lesion model.

In any one of the embodiments above, the method may further include:
determining a position for new tumor in the lesion model; and
adding a tumor model at the position for new tumor in the lesion model.

In any one of the embodiments above, the lesion model may include a vascular model, and the method may further include:
receiving a selection instruction for selecting a vascular model in the lesion model;
determining a selected vascular model in the lesion model according to the received selection instruction;
receiving an adjustment instruction; and
adjusting a position, an orientation, a diameter and/or a radius of the selected vascular model according to the adjustment instruction.

In any one of the embodiments above, the lesion model may include a defect model, and the method may further include:
receiving a selection instruction for selecting a defect model in the lesion model;
determining a selected defect model in the lesion model according to the received selection instruction;
receiving an adjustment instruction; and
adjusting a position and/or a size of the selected defect model according to the adjustment instruction.

In any one of the embodiments above, the lesion model may include a tumor model, and the method may further include:
receiving a selection instruction for selecting a tumor model in the lesion model;
determining a selected tumor model in the lesion model according to the received selection instruction;
receiving an adjustment instruction; and
adjusting a position, a size and/or an orientation of the selected tumor model according to the adjustment instruction.

In any one of the embodiments above, the lesion model may include an atrial model, a ventricular model or a myocardial model, and the method may further include:
receiving a selection instruction for selecting an atrial model, a ventricular model or a myocardial model in the lesion model;
determining a selected atrial model, a selected ventricular model or a selected myocardial model in the lesion model according to the received selection instruction;
receiving an adjustment instruction; and
adjusting a size and/or a position of the selected atrial model or the selected ventricular model, or adjusting a position and/or a thickness of the selected myocardial model according to the adjustment instruction.

In an embodiment, the method may further include:
automatically adjusting a position and/or a size of a defect model associated with the selected atrial model, the selected ventricular model or the selected myocardial model according to the adjustment to the selected atrial model, the selected ventricular model or the selected myocardial model, such that the adjusted defect model matches the adjusted selected atrial model, the adjusted selected ventricular model or the adjusted selected myocardial model.

In any one of the embodiments above, the lesion model may include an aortic valve model, and the method may further include:
receiving a selection instruction for selecting an aortic valve model in the lesion model;
determining a selected aortic valve model in the lesion model according to the received selection instruction;
receiving an adjustment instruction; and
adjusting a position and/or a size of the selected aortic valve model according to the adjustment instruction.

In an embodiment, the method may further include:
automatically adjusting a position and/or a size of a vascular model associated with the selected aortic valve model according to the adjustment to the selected aortic valve model, such that the adjusted vascular model matches the adjusted selected aortic valve model.

In any one of the embodiments above, the lesion model may include a mitral valve model or a tricuspid valve model, and the method may further include:
receiving a selection instruction for selecting a mitral valve model or a tricuspid valve model in the lesion model;
determining a selected mitral valve model or a selected tricuspid valve model in the lesion model according to the received selection instruction;
receiving an adjustment instruction; and
adjusting a position, a size of opening and/or a valve thickness of the selected mitral valve model or the selected tricuspid valve model according to the adjustment instruction.

In any one of the embodiments above, the method may further include:
receiving a selection instruction for selecting a sub-anatomical model in the lesion model;
determining a selected sub-anatomical model in the lesion model according to the received selection instruction;
receiving an adjustment instruction; and
adjusting a position, a shape, a size, an orientation and/or a thickness of the selected sub-anatomical model according to the adjustment instruction.

In any one of the embodiments above, in response to an operation on the lesion type selection interface, determining a determined lesion type of the tissue site from the one or more lesion types in the lesion type selection interface and generating a lesion model of the tissue site based on the determined lesion type may include:
receiving a first selection instruction for selecting a first determined lesion type on the lesion type selection interface;
determining the first determined lesion type according to the received first selection instruction;
determining a first lesion model according to the first determined lesion type;
receiving a second selection instruction for selecting a second determined lesion type on the lesion type selection interface;
determining the second determined lesion type according to the received second selection instruction;
determining a second lesion model according to the second determined lesion type; and
obtaining the lesion model of the tissue site according to the first lesion model and the second lesion model.

In any one of the embodiments above, the method may further include:
determining a position for new sub-anatomical model in the lesion model; and
adding a new sub-anatomical model at the determined position for new sub-anatomical model.

In an embodiment, an apparatus for generating a lesion model of a tissue site is provided, which may include:
a memory configured to store a program; and
a processor configured to execute the program stored in the memory to implement the method of any one of the embodiments above.

In an embodiment, a computer-readable storage medium including a program is provided. The program is executable by a processor to implement the method of any one of the embodiments above.

According to the method and apparatus for generating a lesion model of a tissue site and the computer-readable storage medium, as described in the above embodiments, by obtaining the determined lesion type of the tissue site, determining a plurality of determined sub-anatomical models from the model database of the tissue site based on the determined lesion type of the tissue site, generating the lesion model of the tissue site based on the plurality of determined sub-anatomical models, and displaying the lesion model of the tissue site, the lesion model of a lesion type corresponding to the tissue site can thus be generated.

### BRIEF DESCRIPTION OF THE DRAWINGS

FIG. 1 illustrates a flowchart of a method for generating a lesion model of a tissue site in some embodiments;

FIG. 2 illustrates a schematic diagram of a determined lesion type recognition model in some embodiments;

FIG. 3 illustrates a schematic diagram of an ultrasound imaging system in some embodiments;

FIG. 4 illustrates a flowchart of obtaining the determined lesion type of the tissue site in some embodiments;

FIG. 5(a) illustrates a schematic diagram of a lesion type selection interface in some embodiments;

FIG. 5(b) illustrates a schematic diagram of another lesion type selection interface in some embodiments;

FIG. 6 illustrates exemplary diagrams of the superior vena cava morphology corresponding to left superior vena cava lesion type 1 and the superior vena cava morphology corresponding to left superior vena cava lesion type 2 in some embodiments;

FIG. 7(a) illustrates a schematic diagram of a superimposition process to generate a lesion model of persistent left superior vena cana (PLSVC) type 1 in some embodiments;

FIG. 7(b) illustrates a schematic diagram of a superimposition process to generate a lesion model of PLSVC type 2 in some embodiments;

FIG. 8 illustrates the shared and distinct sub-anatomical models between the lesion model of PLSVC type 1 and the lesion model of PLSVC type 2 in some embodiments;

FIG. 9 illustrates a flowchart of a method for generating a lesion model of a tissue site in some embodiments;

FIG. 10 illustrates a schematic diagram of the addition of a bridging vessel in some embodiments;

FIG. 11 illustrates a schematic diagram of the addition of a vascular branch in some embodiments;

FIG. 12 illustrates a schematic diagram of the addition of a defect in some embodiments;

FIG. 13 illustrates a schematic diagram of the addition of a tumor in some embodiments;

FIG. 14 illustrates a schematic diagram of the editing of local vessel diameter in some embodiments;

FIG. 15 illustrates a schematic diagram of the editing of overall vessel diameter in some embodiments;

FIG. 16 illustrates a schematic diagram of the editing of a tumor in some embodiments;

FIG. 17 illustrates a schematic diagram of the editing of a defect in some embodiments;

FIG. 18 illustrates a schematic diagram of the editing of atrial dimensions, ventricular dimensions, and ventricular wall thickness in some embodiments;

FIG. 19 illustrates a schematic diagram of the editing of an arterial valve in some embodiments;

FIG. 20 illustrates a schematic diagram of the editing of mitral and tricuspid valves in some embodiments;

FIG. 21 illustrates a schematic diagram of the editing of an arterial cone in some embodiments;

FIG. 22 illustrates a schematic diagram of the editing of the superimposing order in some embodiments;

FIG. 23 illustrates a schematic diagram of the replacement of a sub-anatomical model in some embodiments;

FIG. 24 illustrates a schematic diagram of the deletion of a sub-anatomical model in some embodiments;

FIG. 25 illustrates a flowchart of a method for generating a lesion model of a tissue site in some embodiments; and

FIG. 26 illustrates a schematic diagram of the structure of an apparatus for generating a lesion model of a tissue site in some embodiments.

### DESCRIPTION OF THE PREFERRED EMBODIMENTS

The present disclosure will be further described in detail below through specific embodiments with reference to the accompanying drawings. Common or similar elements are referenced with like or identical reference numerals in different embodiments. Many details described in the following embodiments are for better understanding the present disclosure. However, those skilled in the art can realize with minimal effort that some of these features can be omitted in different cases or be replaced by other elements, materials and methods. For clarity some operations related to the present disclosure are not shown or illustrated herein so as to prevent the core from being overwhelmed by excessive descriptions. For those skilled in the art, such operations are not necessary to be explained in detail, and they can fully understand the related operations according to the description in the specification and the general technical knowledge in the art.

In addition, the features, operations or characteristics described in the specification may be combined in any suitable manner to form various embodiments. At the same time, the steps or actions in the described method can also be sequentially changed or adjusted in a manner that can be apparent to those skilled in the art. Therefore, the various sequences in the specification and the drawings are only for the purpose of describing a particular embodiment, and are not intended to be an order of necessity, unless otherwise stated one of the sequences must be followed.

The serial numbers of components herein, such as “first”, “second”, etc., are only used to distinguish the described objects and do not have any order or technical meaning. The terms “connected”, “coupled” and the like here include direct and indirect connections (coupling) unless otherwise specified.

Firstly, due to the complexity of lesion structures in various regions of patients, when doctors diagnose lesion sites using imaging modalities such as ultrasound, they require considerable experience to establish a clear relationship between ultrasound images and parameters and clinical anatomy.

Secondly, for some complex diseases characterized by intricate physiological and anatomical structures, it is difficult to describe the specific conditions of lesion or malformation sites in detail. This often leads to inadequate MDT communication, potentially increasing the risk of misdiagnosis.

Secondly, medical reports (such as ultrasound reports) are mostly textual descriptions, and for complex diseases, these textual descriptions are obscure and difficult to understand, hindering doctors' efforts to educate patients about their conditions.

In some approaches, doctors attempts to describe diseases by hand drawing the anatomical structures of target lesions, but hand drawing requires high drawing skills and knowledge of different diseases. Moreover, the hand drawing process is time-consuming. Few doctors are capable of hand drawing descriptions for complex diseases.

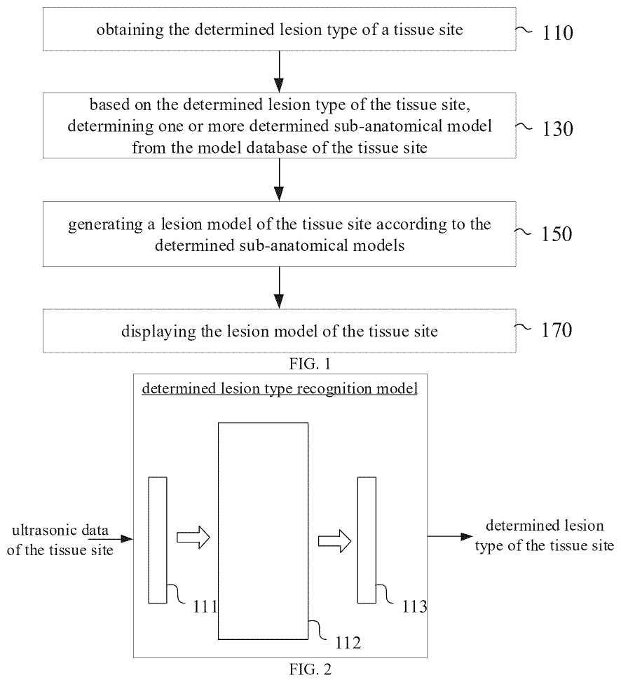

Referring to FIG. 1, a method for generating a lesion model of a tissue site provided in some embodiments may include the following steps:
Step 110: obtaining the determined lesion type of a tissue site.

There are various ways to obtain the determined lesion type of the tissue site in step 110, such as automatically (e.g., via machine learning algorithms) or manually (e.g., user-defined input).

In some embodiments, step 110 involves obtaining the ultrasound data of the tissue site, and automatically recognizing the determined lesion type of the tissue site based on the ultrasound data of the tissue site.

The automatic recognition of the determined lesion type of the tissue site in step 110 can be achieved through methods such as machine learning. For example, step 110 involves inputting the ultrasound data of the tissue site into a determined lesion type recognition model to obtain the determined lesion type; wherein the determined lesion type recognition model is configured to process the ultrasound data of the tissue site as input data and then output the determined lesion type of the tissue site.

Please refer to FIG. 2, in some embodiments, the determined lesion type recognition model includes an input layer 111, an intermediate layer 112, and an output layer 113, with the intermediate layer 112 including a convolutional layer or hidden layer. The determined lesion type recognition model is designed to extract features from the ultrasound data of the tissue site inputted through the input layer 111 via the intermediate layer 112, and then output the determined lesion type of the tissue site through the output layer 113 based on the extracted features.

In some embodiments, the determined lesion type recognition model is obtained through training with a training set. The data in the training set includes first data and second data, where the label for the first data is the second data. The first dataset may be the ultrasound data of the tissue site, and the second dataset may be the corresponding determined lesion type.

In some embodiments, during the training process of the determined lesion type recognition model based on the first data and the second data, the first data is inputted into the determined lesion type recognition model. Through iteration, the output data of the determined lesion type recognition model is continuously made closer to the second data. For example, the error between the output data of the determined lesion type recognition model and the second data is estimated, the parameters of the determined lesion type recognition model is updated based on this error. The above steps are repeated to iteratively update the parameters of the determined lesion type recognition model until the error between the output data of the determined lesion type recognition model and the second data is within a predetermined ranged.

In some embodiments, the determined lesion type recognition model includes: a model based on convolutional neural network, a model based on recurrent neural network, a model based on adversarial neural network, a model based on attention neural network, and/or a model based on fully connected network.

It shall be noted that the ultrasound data is obtained based on ultrasound imaging procedures which utilize ultrasound waves to scan human tissues or organs and obtain images of corresponding regions through the reception and processing of reflected signals.

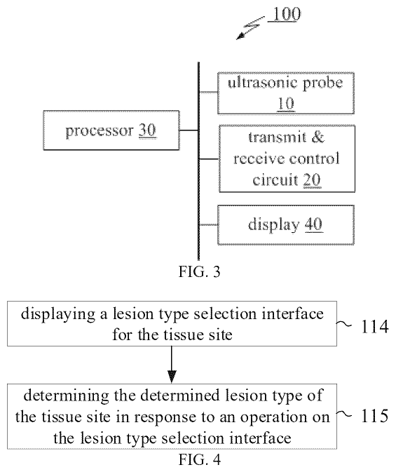

For example, FIG. 3 illustrates an example of an ultrasound imaging system 100 that may include an ultrasound probe 10, a transmit and receive control circuit 20 and a processor 30. In some embodiments, the ultrasound imaging system 100 may further comprise a display 40. These components are described below.

In some embodiments, the ultrasound probe 10 is configured to transmit ultrasound waves and receive echo signals of the ultrasound waves. In some specific embodiments, the ultrasound probe 10 comprises a plurality of transducer elements for mutual conversion between electrical pulse signals and ultrasound waves, thereby enabling the transmission of ultrasound waves to a tissue site and the reception of ultrasound echoes from tissues so as to obtain the echo signals of the ultrasound waves. In some embodiments, the plurality of transducer elements included in the ultrasound probe 10 can be arranged in a single row to form a linear array. In some embodiments, the plurality of transducer elements included in the ultrasound probe 10 are arranged in a two-dimensional matrix to form a planar array. The transducer elements, which for example employ piezoelectric crystals, convert electrical signals into ultrasound signals according to a transmission sequence from the transmit and receive control circuit 20. Depending on the application, the transmitted ultrasound waves (ultrasound signals) may include one or more scanning pulses, one or more reference pulses, one or more push pulses, and/or one or more Doppler pulses. According to the wave form, the ultrasound signals include focused waves, plane waves, and divergent waves. The transducer elements are used to transmit ultrasound waves based on excitation electrical signals, or to convert received ultrasound waves into electrical signals; accordingly, each transducer element can be used to achieve mutual conversion between electrical pulse signals and ultrasound waves, enabling the transmission of ultrasound waves to a tissue site and the reception of echo signals of ultrasound waves from tissues. During ultrasound inspection, the transmit and receive control circuit 20 can control which transducer elements are used to transmit ultrasound beams (referred to as transmitting transducer elements), which transducer elements are used to receive ultrasound beams (referred to as receiving transducer elements), or control the transducer elements to be used in time slots for emitting ultrasound waves or receiving echoes of the ultrasound waves. The transducer elements involved in transmission of ultrasound waves can be simultaneously excited by electrical signals to transmit ultrasound waves concurrently; alternatively, they can be excited by a plurality of electrical signals with certain time intervals to continuously transmit ultrasound waves with specific time intervals. If the minimum processing area for receiving and reflecting ultrasound waves in the tissue site is referred to as a location point within the tissue, then after the ultrasound waves reach each location point in the tissue site, they will produce different reflections due to the different acoustic impedances of the tissues at different location points. The reflected ultrasound waves are picked up by the receiving transducer elements, and each receiving transducer element may receive echoes of ultrasound waves (i.e., ultrasound echoes) from multiple location points. The ultrasound echoes from different location points received by each receiving transducer element may form different channel echo data. For a particular receiving transducer element, its distances to different location points in the tissue site vary, so the times at which the ultrasound echoes reflected from various location points arrive at the transducer element also differ. The correspondence between the ultrasound echoes and the location points can be identified based on the arrival times of the ultrasound echoes at said particular transducer element.

The transmit and receive control circuit 20 is configured to control the ultrasound probe 10 to transmit ultrasound waves and receive echo signals of the ultrasound waves. For instance, the transmit and receive control circuit 20 serves to control the ultrasound probe 10 to transmit ultrasound waves towards a tissue site on the one hand, and to control the ultrasound probe 10 to receive ultrasound echoes reflected from tissues on the other hand. In some specific embodiments, the transmit and receive control circuit 20 is used to generate transmitting sequences and receiving sequences, which are then output to the ultrasound probe 10. The transmitting sequences are used to control some or all of the plurality of transducer elements in the ultrasound probe 10 to transmit ultrasound waves towards the tissue site. The parameters of the transmitting sequences include the number of transducer elements used for transmission and transmission parameters for ultrasound waves (such as pulse amplitude, transmit voltage, transmit frequency, number of transmissions, transmit interval, transmit angle, transmit waveform, transmit aperture, line density, pixel density, and/or focal position, etc.). The receiving sequences are used to control some or all of the plurality of transducer elements to receive ultrasound echo waves from tissues. The parameters of the receiving sequences include the number of transducer elements used for reception and the reception parameters for the echoes (such as reception angle, depth, etc.). Depending on the different uses of the ultrasound echoes or the different images generated from the ultrasound echoes, the parameters for the ultrasound waves in the transmitting sequences and the parameters for the echoes in the receiving sequences may be different.

The processor 30 is configured to process the ultrasound echo signals received by the ultrasound probe 10 (i.e., echo signals of the ultrasound waves), such as processing the ultrasound echo signals/channel echo data in one or more steps, including analog-to-digital conversion, signal demodulation, amplification, filtering, downsampling, beamforming, modulus operation, logarithmic compression, and/or grayscale transformation. The processor 30 can process the echo signals of ultrasound waves to obtain ultrasound images for display on the display 40.

In some embodiments, the processor 30 includes, but is not limited to, devices such as those that interpret computer instructions and process data within computer software, such as a central processing unit (CPU), a micro controller unit (MCU), a field-programmable gate array (FPGA), and digital signal processing (DSP) units.

The above are some descriptions of the ultrasound imaging system 100.

It shall be noted that the ultrasound data of the tissue site obtained in step 110 may be data from any steps of the process, ranging from the echo signals of the ultrasound waves/channel echo data to the ultrasound images.

The ultrasound data of the tissue site may be obtained in real time using an ultrasound imaging apparatus, or may be obtained by reading ultrasound data that has been pre-acquired and stored in memory. The pre-acquired and stored ultrasound data may be stored locally, or may be stored on a remote server, a cloud server, another ultrasound device, or another electronic device, etc.

The above is a description of automatically recognizing the determined lesion type based on the ultrasound data of the tissue site.

As mentioned above, the determined lesion type of the tissue site can be obtained manually in step 110. Please refer to FIG. 4, step 110 in some embodiments may include the flowing steps:
Step 114: displaying a lesion type selection interface for the tissue site.
Step 115: determining the determined lesion type of the tissue site in response to an operation on the lesion type selection interface based on the ultrasound data.

In some examples, the lesion type selection interface includes a plurality of options, with each option corresponding to a specific lesion type for the tissue site.

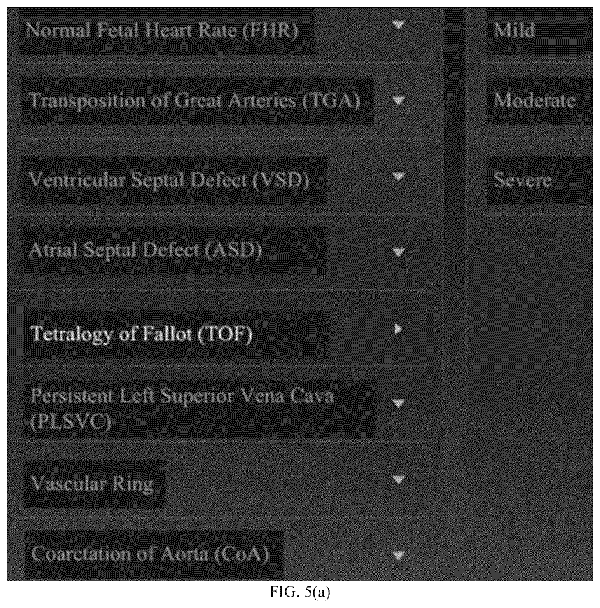

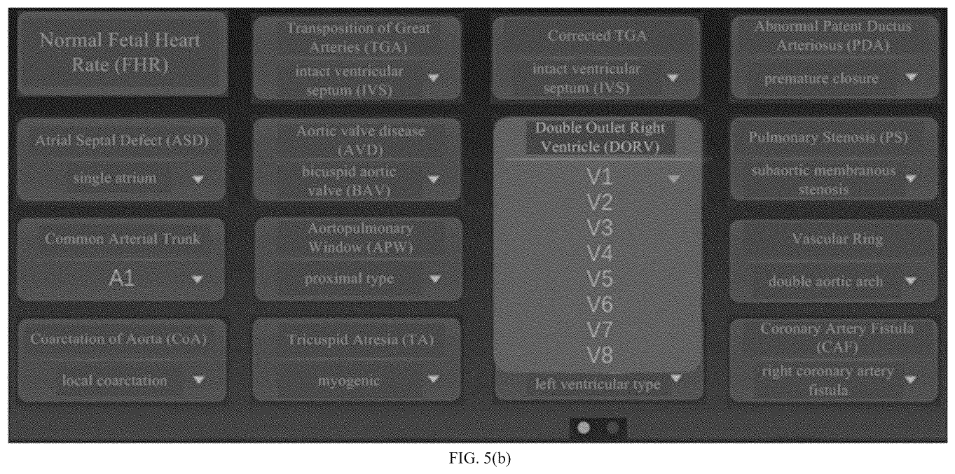

FIG. 5(a) and 5(b) illustrate two examples of, when the tissue site is the heart, the lesion type selection interface for the tissue site displayed. In some cases, doctors can use echocardiography to determine the structural abnormalities and their severity in a patient's heart, allowing them to diagnose the patient's congenital heart disease (i.e., determining the determined lesion type of the tissue site). After reaching a diagnostic conclusion, doctors can use the illustrated lesion type selection interface to select the congenital heart disease and its corresponding subtype, thereby selecting the determined lesion type of the heart on the interface. A lesion model generation device (e.g., an ultrasound imaging apparatus, an ultrasound workstation, other electronic devices capable of implementing the lesion model generation methods herein, etc.) may receive the doctor's operation on the selection interface, and in response to the operation, the lesion model generation device may determine (know) the type of the lesion (lesion type) at the tissue site.
Step 130: determining one or more determined sub-anatomical models from the model database of the tissue site based on the determined lesion type of the tissue site. For example, step 130 involves determining one or more determined sub-anatomical models associated with the determined lesion type from the model database of the tissue site based on the determined lesion type of the tissue site.

In some embodiments, the model database of the tissue site includes a plurality of sub-anatomical models. The plurality of sub-anatomical models includes category of general sub-anatomical model. This category of general sub-anatomical model is configured to define a complete anatomical structure of the tissue site (also referred to as general anatomical structure).

In some embodiments, at least one category of general sub-anatomical model mentioned above includes a plurality of general sub-anatomical model that are identical in category but different in morphology and are configure to distinguish the lesion types of the tissue site.

In some embodiments, the plurality of sub-anatomical models mentioned above further includes category of special sub-anatomical model configured to distinguish the lesion types of the tissue site.

It shall be understood that the complete (or general) anatomical model of the tissue site includes one or more general sub-anatomical models. These general sub-anatomical models can be obtained by dividing the tissue site anatomically based on general medical anatomical knowledge, thereby defining the complete anatomical structure of the tissue site.

Furthermore, based on different lesion types of the tissue site, a general sub-anatomical model of the same category may exhibit multiple different morphologies. Thus, general sub-anatomical model of the same category but with different morphologies can be used to distinguish lesion types of the tissue site. That is, when the lesion type of the tissue site involves a general sub-anatomical model of a certain category, this category of general sub-anatomical model has a corresponding morphology for each associated lesion type. It shall be understood that in the case where the lesion type of the tissue site does not involve a general sub-anatomical model of a certain category, then the morphology of this category of general sub-anatomical model for that lesion type is normal and non-lesioned.

Therefore, for at least one category of general sub-anatomical models, it may include a normal, non-lesioned morphology, and a non-lesioned morphology corresponding to the lesion type of the tissue site.

Furthermore, in addition to the complete (or general) anatomical model of the tissue site, there may also be a special sub-anatomical model. The special sub-anatomical model does not exist in the normal, non-lesioned anatomical model of the tissue site, and are therefore capable of distinguishing between different lesion types of the tissue site. An example of such a special sub-anatomical model can be a tumor, which will be further explained below.

It can be seen that a complete (or general) anatomical model of the tissue site can be constructed through the general sub-anatomical models. Based on this, different lesion types of the tissue site can be defined by utilizing the general sub-anatomical models that are of the same category but with different morphologies; and additionally or alternatively, the different lesion types of the tissue site can be defined through the special sub-anatomical model.

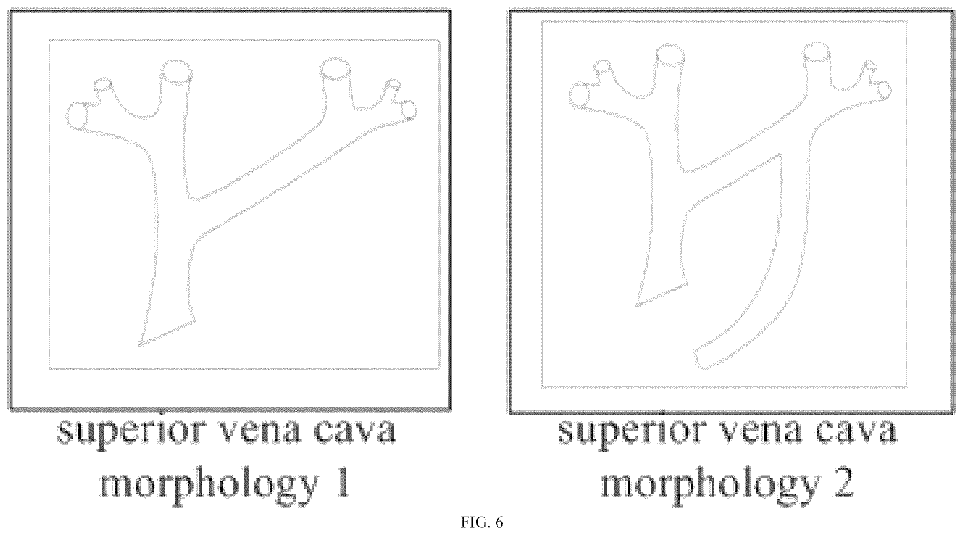

Taking the tissue site as a heart or fetal heart as an example. The model database for the heart/fetal heart includes a plurality of sub-anatomical models. The plurality of sub-anatomical models include category of general sub-anatomical model, or category of general sub-anatomical model and category of special sub-anatomical model. The category of general sub-anatomical model is used to define the complete anatomical structure (general anatomical structure) of the heart/fetal heart. In some examples, the category of general sub-anatomical model may include at least one of the following: chambers (left and right atria and ventricles), myocardial tissue, arterial vessels (main and pulmonary arteries and their branches, arterial cones, arterial ducts, etc.), valves (mitral, tricuspid, aortic, and pulmonary valves), and venous vessels (superior vena cava, inferior vena cava, pulmonary veins, innominate veins, etc.). Furthermore, the at least one category of general sub-anatomical models includes a plurality of general sub-anatomical model of the same category but with different morphologies for distinguishing between different lesion types of the heart/fetal heart. For example, considering the persistent left superior vena cava (PLSVC) lesion, it is generally classified into PLSVC type 1 and PLSVC type 2 based on a connection site. Thus, for the general sub-anatomical model of the superior vena cava, it includes two general sub-anatomical models of the superior vena cava that are identical in category (both being superior vena cava) but differ in morphology, corresponding to PLSVC type 1 and PLSVC type 2 respectively. FIG. 6 illustrates exemplary diagrams of the superior vena cava morphology corresponding to left superior vena cava lesion type 1 and the superior vena cava morphology corresponding to left superior vena cava lesion type 2. Consequently, the general sub-anatomical models including chambers (left and right atria and ventricles), myocardial tissue, arterial vessels (main and pulmonary arteries and their branches, arterial cones, arterial ducts, etc.), valves (mitral, tricuspid, aortic, and pulmonary valves), and venous vessels (superior vena cava, inferior vena cava, pulmonary veins, innominate veins, etc.) can include both the normal, non-lesioned morphology and the lesioned morphology corresponding to the lesion types of the heart/fetal heart that are related to them. Additionally, in some examples, the at least one category of special sub-anatomical models includes at least one of a defect, foramen ovale, and a tumor.

Taking the tissue site as blood vessels as another example. The model database of blood vessels includes a plurality of sub-anatomical models that include category of general sub-anatomical models, or category of general sub-anatomical models and category of special sub-anatomical models. The category of general sub-anatomical models are used to define the complete anatomical structure (general anatomical structure) of blood vessels. In some examples, the category of general sub-anatomical models include at least one of coronary arteries, carotid arteries, abdominal aorta, and superficial veins. Furthermore, these at least one category of general sub-anatomical models include a plurality of general sub-anatomical models of the same category but with different morphologies to distinguish different lesion types in blood vessels. Therefore, these general sub-anatomical models such as coronary arteries, carotid arteries, abdominal aorta, and superficial veins can include normal, non-lesioned morphologies, as well as lesioned morphologies corresponding to the lesion types related to blood vessels. In addition, in some examples, the category of special sub-anatomical models include at least one of plaques, hemangiomas, embolisms.

In summary, the model database of the tissue site includes a plurality of sub-anatomical models. The plurality of sub-anatomical models include category of general sub-anatomical models, or category of general sub-anatomical models and category of special sub-anatomical models. Therefore, in step 130, based on the determined lesion type of the tissue site, one or more sub-anatomical models associated with the determined lesion type are determined from the model database of the tissue site as the target sub-anatomical model. With these sub-anatomical models associated with the determined lesion type, not only can the complete anatomical structure of the tissue site be defined, but also the determined lesion type of the tissue site can be reflected.
Step 150: generating a lesion model of the tissue site based on the plurality of determined sub-anatomical models determined in step 130. For example, step 150 involves superimposing the plurality of determined sub-anatomical models determined in step 130 in a certain order to generate a lesion model.
Step 170: displaying the lesion model of the determined lesion type corresponding to the target.

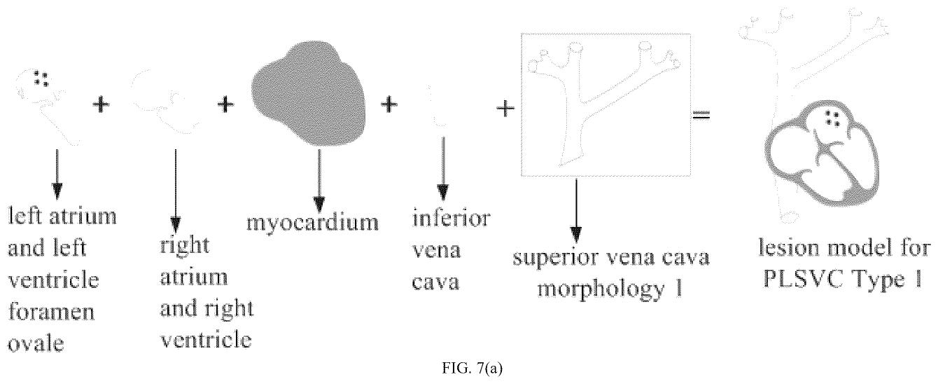

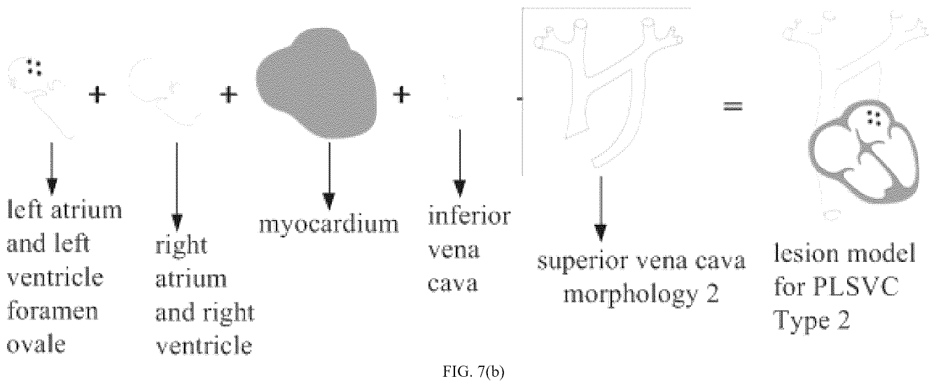

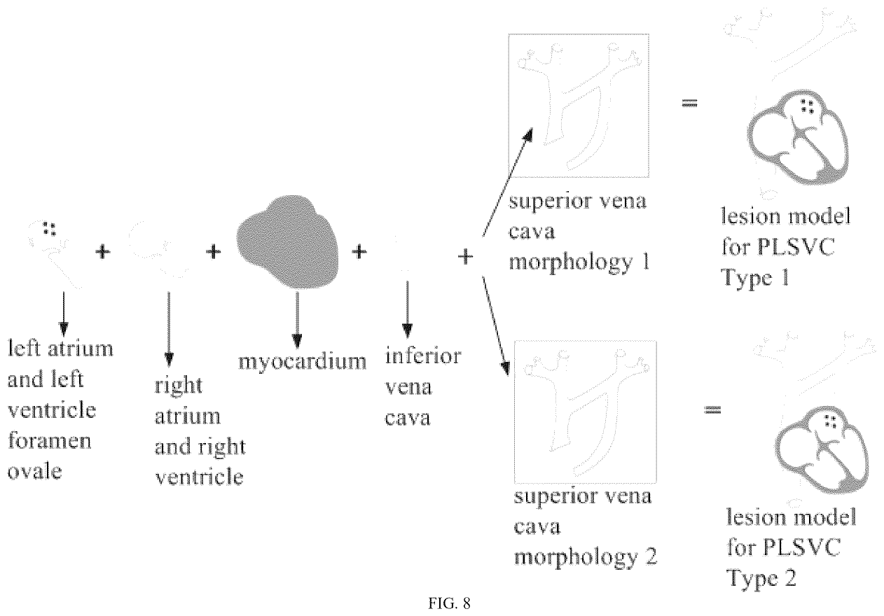

FIG. 7(a) presents an example of the display of a lesion model for PLSVC type 1. It involves: (1) identifying a determined lesion type of the heart/fetal heart as PLSVC type 1; (2) based on PLSVC type 1 of the heart/fetal heart, determining a plurality of determined sub-anatomical models from the model database of the heart/fetal heart. The determined sub-anatomical models include the left atrium, right atrium, left ventricle, right ventricle, foramen ovale, myocardium, inferior vena cava, and superior vena cava. Among them, the left atrium, right atrium, left ventricle, right ventricle, foramen ovale, myocardium, and inferior vena cava exhibit normal, non-lesioned morphologies, while the superior vena cava exhibits the lesioned morphology corresponding to PLSVC Type 1. By orderly superimposing these determined sub-anatomical models, the lesion model for PLSVC Type 1 is generated. Similarly, FIG. 7(b) presents an example of the display of the lesion model for PLSVC Type 2. It involves: (1) identifying a determined lesion type of the heart/fetal heart as PLSVC type 2; (2) based on PLSVC type 2 of the heart/fetal heart, determining a plurality of determined sub-anatomical models from the model database of the heart/fetal heart. The determined sub-anatomical models include the left atrium, right atrium, left ventricle, right ventricle, foramen ovale, myocardium, inferior vena cava, and superior vena cava. Among them, the left atrium, right atrium, left ventricle, right ventricle, foramen ovale, myocardium, and inferior vena cava exhibit normal, non-lesioned morphologies, while the superior vena cava exhibits the lesioned morphology corresponding to PLSVC Type 2. By orderly superimposing these determined sub-anatomical models, the lesion model for PLSVC Type 2 is generated. As shown in FIG. 8, for PLSVC lesions, the lesion models of both Types 1 and 2 share the same structures of the left atrium, right atrium, left ventricle, right ventricle, foramen ovale, myocardium, and inferior vena cava (all exhibiting normal, non-lesioned morphologies), with the only difference lying in the morphology of the superior vena cava. Therefore, the present disclosure not only reduces modeling time but also improves the consistency between models of different types.

Therefore, from another perspective, in some embodiments, the model database of the target region includes N different categories of general sub-anatomical models, which can define the complete/universal anatomical structure of the target region. In some cases, there is at least one category of the N different categories of general sub-anatomical models in only one morphology, namely the normal, non-lesioned morphology. In some cases, there is at least one category of the N different categories of general sub-anatomical models in at least two morphologies, including one normal, non-lesioned form and other morphologies corresponding to specific determined lesion types. In some cases, the model database of the tissue site further includes M special sub-anatomical models, which do not exist in the normal, non-lesioned anatomical model of the target region. Accordingly, the special sub-anatomical models are used to distinguish lesion types of the target region. An example of a special sub-anatomical model may be a tumor. These different situations are primarily determined by the types of determined lesion types to which/with which the model database of the tissue site is targeted/associated.

Correspondingly, in some examples, after identifying the determined lesion type of the tissue site, based on this determined lesion type of the tissue site, the morphology corresponding to the determined lesion type for each general sub-anatomical model is determined through each general sub-anatomical model in the model database of the tissue site, and the general sub-anatomical model with the determined morphology is selected as a target general sub-anatomical model; when the determined lesion type involves a special sub-anatomical model, the special sub-anatomical model associated with/corresponding to the determined lesion type, or the special sub-anatomical model and its corresponding morphology associated with/corresponding to the determined lesion type, is determined from the model database of the tissue site, to serve as the target general sub-anatomical model; and finally, based on these determined sub-anatomical models, a lesion model of the tissue site is generated and displayed.

The above is an explanation of how to generate lesion models corresponding to different lesion types for the tissue site. In some examples, users can also edit the generated lesion model of the target region, such as adding, deleting, and/or adjusting sub-anatomical models. This significantly enhances the applicability of the lesion model while also reducing the data volume and complexity of the model database for the tissue site.

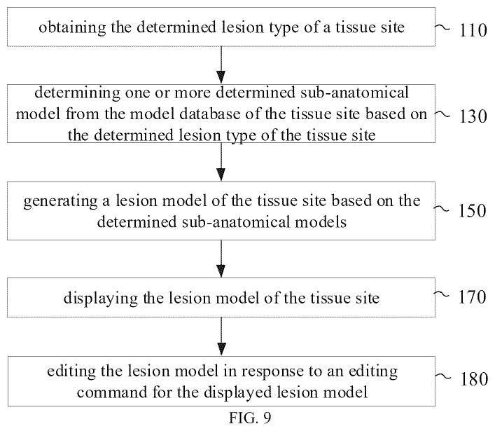

Referring to FIG. 9, a method for generating a lesion model of a tissue site provided in some embodiments also comprises step 180: in response to an editing command for the displayed lesion model, editing the lesion model.

In some examples, Step 180 involves editing the lesion model, with each sub-anatomical model treated as a unit for editing. For example, users can interact with the lesion model using tools such as a mouse to select the sub-anatomical model for editing. Based on the category of the selected sub-anatomical model, corresponding editing options are displayed, which permit specific editing operations tailored to that category. It is worth noting that different categories of sub-anatomical models may offer different editing capabilities; for instance, the wall thickness of atria and ventricles can be adjusted, while the size and orientation of tumors can be modified. Users then proceed to edit the selected sub-anatomical model by selecting from the displayed editing options specific to its category.

In some embodiments, step 180, which involves editing the lesion model, may include at least one of the following:
1. Adding one or more one or more sub-anatomical models to the lesion model; for example, when the tissue site includes a fetal heart or heart, adding one or more sub-anatomical models to the lesion model includes at least one of the following: adding a vascular branch in the lesion model, adding a bridging vessel in the lesion model, adding a tumor in the lesion model, and adding a defect in the lesion model;
2. Deleting one or more sub-anatomical models contained in the lesion model; and
3. Editing the morphology and/or position of one or more sub-anatomical models contained in the lesion model; for example, when the tissue site includes a fetal heart or heart, editing the morphology and/or position of one or more sub-anatomical models contained in the lesion model includes at least one of the following: editing the thickness of the entire or local vessels in the lesion model; editing the size, position, and/or orientation of a tumor in the lesion model; editing the size of an atrium or ventricle in the lesion model; editing the wall thickness of an atrium or ventricle in the lesion model; editing the size of an arterial valve in the lesion model; editing the opening size of a mitral valve or tricuspid valve in the lesion model; editing the thickness of a mitral valve or tricuspid valve in the lesion model; editing the thickness of an arterial cone in the lesion model; editing the stacking order of the sub-anatomical models in the lesion model.

Below, the example of the tissue site being the heart or fetal heart is taken to illustrate with reference to accompanying drawings.

### (1) Editing of Newly Added Blood Vessels

The addition of new blood vessels can encompass the addition of a bridging vessel and/or a vascular branch. The addition of a bridging vessel involves incorporating a new vessel to connect two existing vessels within the lesion model. Meanwhile, the addition of a vascular branch refers to branching off a separate vascular bifurcation from an existing vessel within the lesion model.

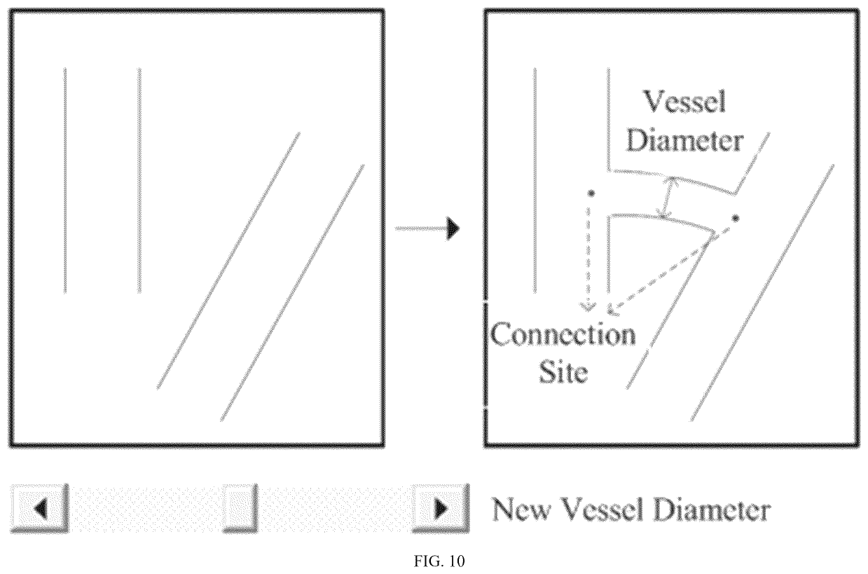

FIG. 10 illustrates an example of adding a bridging vessel. The process of adding a new bridging vessel mainly involves the following steps:
Determining the connection positions of two blood vessels in the lesion model: For example, the connection position for each vessel is determined by clicking on positions on the two vessels, respectively.
Additionally, determining which side of the vessel wall the new vessel is connected to is based on the connection positions on the vessels. Specifically, when a connection position is determined by clicking on a position on one of the vessels, it is judged on which side wall of the currently clicked vessel the new vessel is connected.
After determining which side wall of the original vessel the new vessel is connected to, establishing the connection path of the new vessel based on this information and the determined connection positions of the two vessels. Then, the corresponding vessel is added to the lesion model based on the connection path of the new vessel.

The method used to determine the connection path can be solved through interpolation methods, including spline interpolation or Lagrange interpolation. Other methods are not fully listed here.

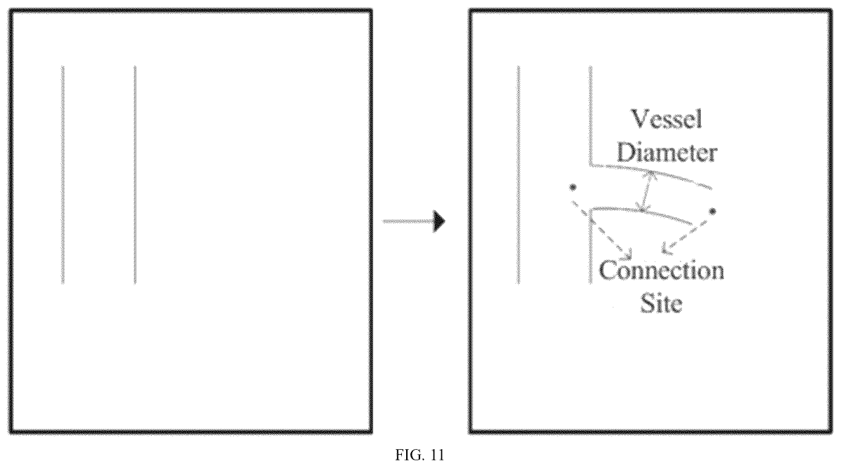

FIG. 11 provides an example of adding a vessel branch. The process of adding a vessel branch mainly includes the following:
Determining the vessel to be branched and the location of the vessel branch: For instance, a vessel is designated as the vessel to be branched by clicking on a position on it, and the clicked position on the vessel is identified as the vessel branch location. The direction of the vessel branch is determined by clicking on a blank region.
(Additionally,) Determining which side wall of the vessel the vessel branch is located by evaluating the vessel branch position on the vessel: Specifically, when the vessel to be branched and the vessel branch position are determined by clicking on a position on the vessel, it is judged on which side wall of the currently clicked vessel the new vessel branch will be connected.
After determining which side wall of the original vessel the new vessel branch is connected to, establishing the connection path of the new vessel branch based on this information, the vessel branch position, and the position of the clicked blank region. Then, the corresponding vessel branch is added to the lesion model based on the connection path of the new vessel branch.

The method used to determine the connection path can be solved through interpolation methods, including spline interpolation or Lagrange interpolation. Other methods are not fully listed here.

It can be seen that whether it is adding a bridging vessel or a vessel branch, the essence is the addition of a new vessel. Therefore, from the perspective of user operation, users only need to determine two positions: for adding a bridging vessel, the connection positions on the two vessels are determined; and for adding a vessel branch, the vessel branch position on one vessel and another position for the vessel branch (the position of the clicked blank region mentioned above) are determined. In this way, users only need to click two positions, a first position and a second position, using tools such as a mouse; the apparatus will then add a new vessel based on these two positions.

Moreover, for both original vessels and newly added vessels, users can also edit the vessel diameter. For instance, sliders or knobs can be provided to change the newly added vessel diameter. In an example, after selecting one or more vessels by a user, the apparatus can adjust the selected vessel diameter based on an operation instruction from a diameter editing control (such as a slider control or a knob control), making them thicker or thinner. This will be further explained below.

### (2) Editing of Newly Added Defects

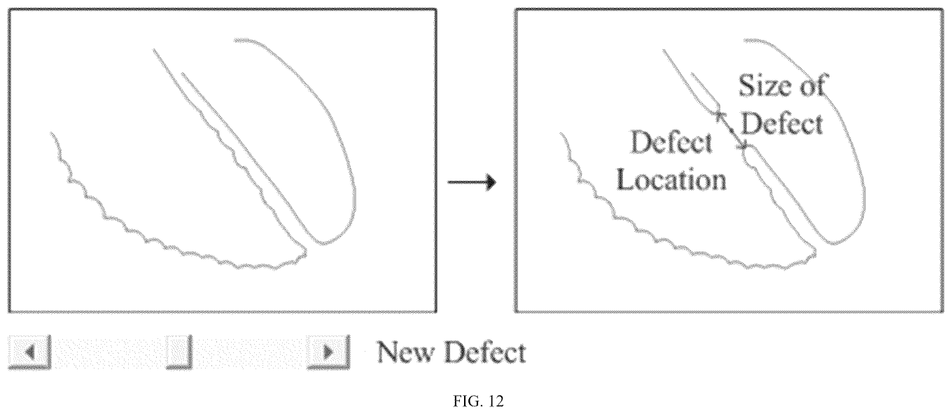

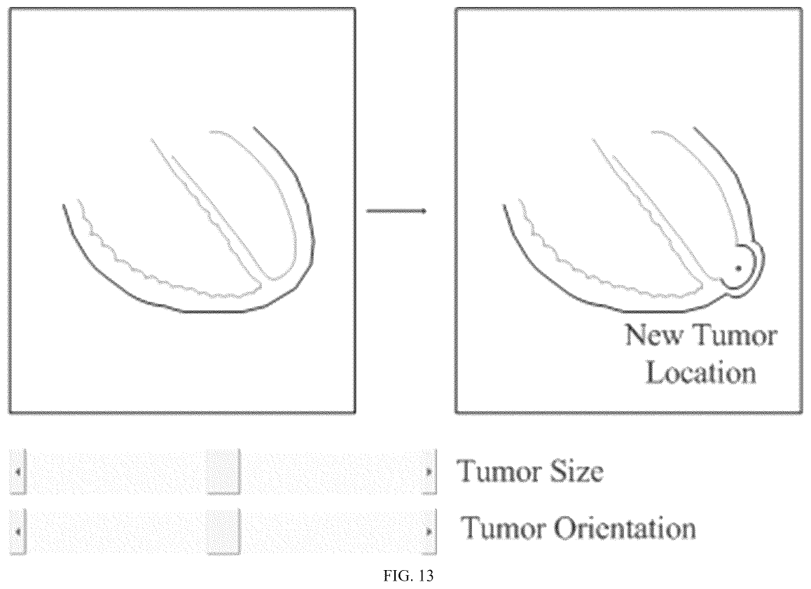

The addition of new defects includes but is not limited to the addition of new ventricular septal defects, the addition of new atrial septal defects, and the addition of new atrioventricular septal defects. FIG. 12 illustrates an example of adding a new defect. The process of adding a new defect mainly comprises the following steps:
Determining the location of the new defect: for instance, clicking on the atrial septum for a new atrial septal defect or clicking on the ventricular septum for a new ventricular septal defect; and
Adding the sub-anatomical model of the defect and placing it above two adjacent structures (which include but are not limited to atria and ventricles).

The purpose of adding a new defect is to establish a connection between the two sub-anatomical models by introducing a defect.

Furthermore, regardless of whether it is an original defect or a newly added defect, users can also edit the size (dimension) of the defect. In an example, after selecting one or more defects by a user, the apparatus can adjust the size of the selected defect larger or smaller based on an operation instruction from a size editing control (such as a slider control or a knob control). This will be further explained below.

### (3) Adding of New Tumors

The addition of new tumors includes but is not limited to new ventricular aneurysms, new atrial tumors, and new rhabdomyomas. FIG. 13 illustrates an example of adding a new tumor. The process of adding a new tumor mainly involves the following steps:
Determining the location of the new tumor: for instance, selecting the location by clicking by users, such as clicking on the ventricle for a new ventricular aneurysm or clicking on the atrium for a new atrial tumor; and
Adding the sub-anatomical model of the tumor and placing it at the determined location of the new tumor.

The purpose of adding a new tumor is to generate lesion models for such as cardiac chamber bulging lesions or heart tumors.

Furthermore, regardless of whether it is an original tumor or a newly added one, users can also edit the size and/or orientation of the tumor. In an example, after selecting a tumor by a user, the apparatus can enlarge or reduce the size of the selected tumor based on an operation instruction from a size editing control (e.g., a slider control or a knob control). Additionally, the apparatus can rotate the selected tumor clockwise or counterclockwise around its center based on an operation instruction from an orientation editing control (e.g., a slider control or a knob control). This will be further explained below.

### (4) Editing of Local Blood Vessel Diameter

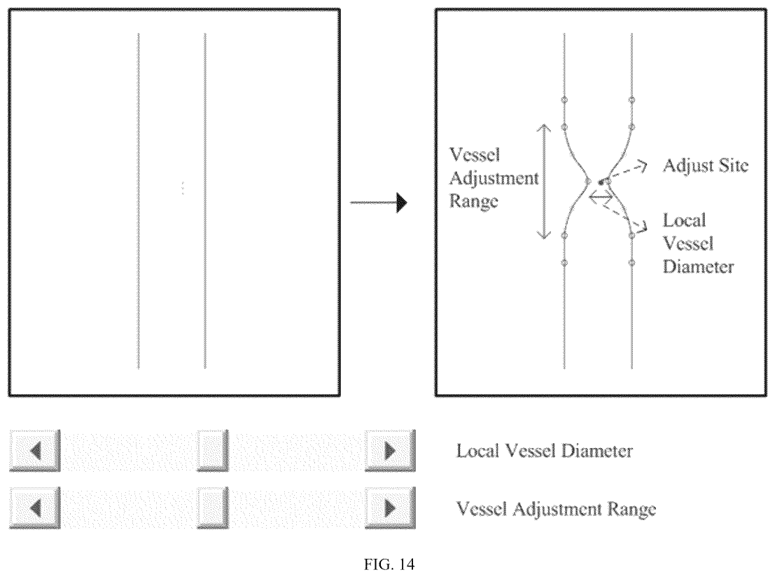

The editing of local blood vessel diameter primarily focuses on adjusting the diameter (narrowing or widening) of a local region within a blood vessel. FIG. 14 illustrates an example of editing local blood vessel diameter, which may mainly comprise the following steps:
Determining the local blood vessel to be edited, or determining the blood vessel and the local position within it to be edited: Users can determine this by clicking on a position on the blood vessel. Examples of blood vessels include, but are not limited to, the aorta, pulmonary artery, superior vena cava, and pulmonary veins.
Adjusting the local diameter of the blood vessel through operation instructions from a (blood vessel) local diameter editing control (such as a slider control or knob control). Additionally, a local range editing control (such as a slider control or knob control) may be employed to modify the size of the local region within the blood vessel to be edited.

In an example, the local range editing control is used to smooth the transition range after the blood vessel diameter change, with a larger editing range resulting in a smoother transition. A specific implementation process is as follows: on the blood vessel walls corresponding to the position clicked, a plurality of equidistant points (e.g., seven points labeled p1 to p7) are selected on each side of the blood vessel wall. Here, p4 represents the point on the blood vessel wall closest to the position clicked on the blood vessel (i.e., the midpoint of p1-p7). The point p4 and its counterpart on the opposite wall are adjusted along their connecting line to narrow or widen the blood vessel. Points p3 and p5 on each side are adjusted to one-third of the displacement applied to p4, while the remaining points remain unchanged. Interpolation methods (e.g., spline interpolation) are then applied to refit the modified vessel contours, thereby achieving editing of local blood vessel diameter.

### (5) Editing of Overall Vessel Diameter

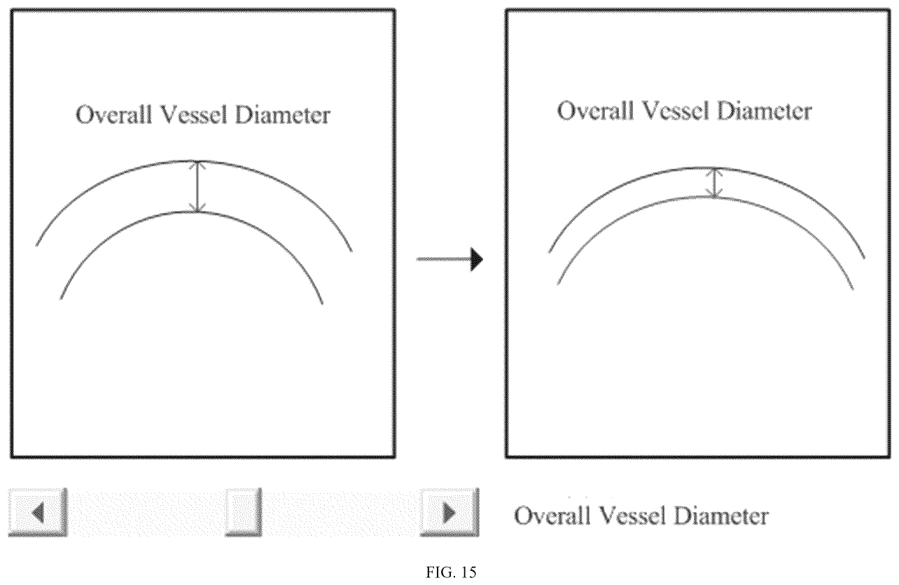

The editing of overall blood vessel diameter is primarily used to adjust the overall diameter (narrowing or widening) of a blood vessel. FIG. 15 illustrates an example of editing overall blood vessel diameter, which may mainly include the following steps:
Determining the blood vessel to be edited: Users can select the blood vessel to be edited by clicking. In an example, blood vessels include but are not limited to the aorta, pulmonary arteries, superior vena cava, pulmonary veins, etc.
Editing the blood vessel diameter: After selecting one or more blood vessels by a user, the apparatus can adjust the thickness of the selected blood vessels based on an operation instruction from a diameter editing control (such as a slider control or a knob control), making them thicker or thinner. One possible implementation algorithm may involve calculating the nearest points from the discretized points located on one side of the blood vessel wall that is intended for movement, to their nearest points on the opposite blood vessel wall, and determining the movement direction and distance of a first point on the side of the blood vessel wall to be moved relative to its nearest point on the opposite blood vessel wall based on fine editing, thereby achieving the editing of the overall diameter of this blood vessel.

In some examples, during the overall diameter editing of a blood vessel, changes occur on both sides of the vessel, which may result in the concurrent adjustment of its connected sub-anatomical models, such as other blood vessels, arterial valves, and arterial cones. For instance, the overall diameter editing of the main aortic blood vessel may require the concurrent adjustment of the descending aorta, aortic duct, and main aortic valve. Similarly, the overall diameter editing of pulmonary blood vessels may necessitate the concurrent adjustment of pulmonary arterial valves, arterial cones, and pulmonary blood vessel branches. Furthermore, the overall diameter editing of pulmonary blood vessel branches may require the concurrent adjustment of the main pulmonary blood vessel. In some examples, the adjusted blood vessels can be edited in diameter (e.g., proportionally becoming thicker or thinner) based on the diameter editing of the original blood vessel, while other non-vascular sub-anatomical models can be proportionally enlarged or reduced.

### (6) Editing of Tumor Size, Location, and Orientation

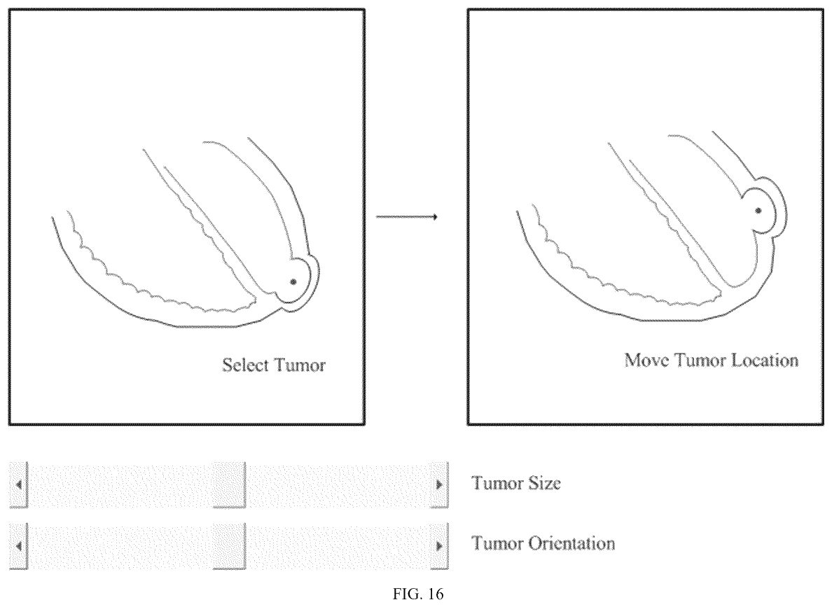

Tumor editing mainly includes the modification of tumor size, location, and orientation. The types of tumors that can be edited include, but are not limited to, ventricular aneurysms, atrial appendage tumors, and rhabdomyomas. FIG. 16 illustrates an example of tumor editing, which involves the following steps:
Determining the tumor to be edited, for instance, by clicking on it for selection.
Moving the tumor by dragging it to change its location.
Resizing the selected tumor by using a size editing control (such as a slider control or a knob control) to make it larger or smaller.
Rotating the selected tumor clockwise or counterclockwise around its center based on an operation instruction from an orientation editing control (such as a slider control or a knob control).

Additionally, the tumor editing process may be accompanied by changes in the lateral myocardium, particularly in cases of ventricular aneurysms and atrial appendage tumors.

### (7) Editing of the Size and Location of the Defect

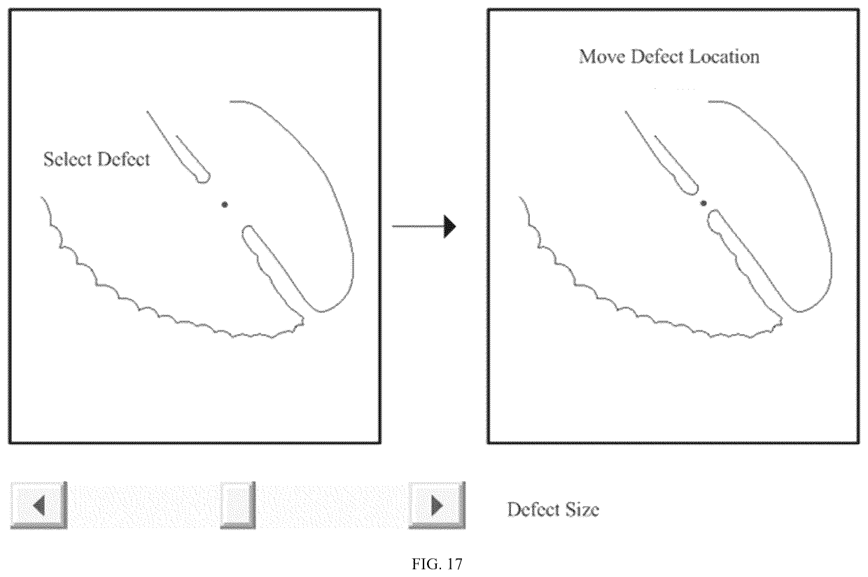

Defect editing primarily involves modifying the size and location of defects. The types of defects that can be edited include, but are not limited to, ventricular septal defects, atrial septal defects, and atrioventricular septal defects. FIG. 17 provides an example of defect editing, which mainly includes the following steps:
Determining the defect to be edited, for instance, by clicking on it for selection.
Moving the defect by dragging it to change its location.
Resizing the selected defect based on an operation instruction from a size editing control (such as a slider control or a knob control) to make it larger or smaller.

### (8) Editing of Atrial, Ventricular, and Ventricular Wall Thickness

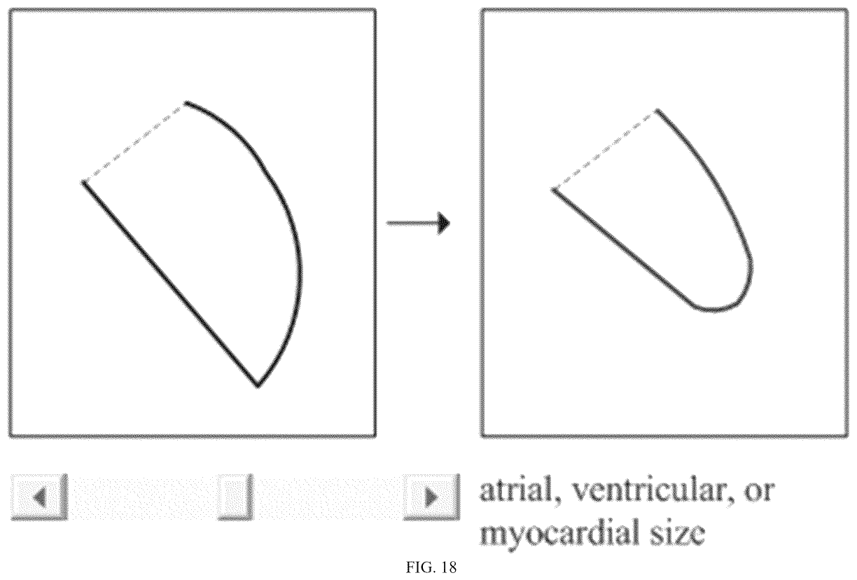

The editing of atrial, ventricular, and ventricular wall thickness primarily used to modify the size of the atria, ventricles, and the thickness of the ventricular wall (myocardial size). FIG. 18 presents an example of this editing process, which mainly includes the following steps:
Determining the atrial, ventricular, or myocardial structure to be edited, for instance, by clicking on it for selection;
Maintaining the fixed positions of the two endpoints and adjusting the distance between the structure's edge points and the line formed by these endpoints in a proportional manner. The size of the structure may be altered by utilizing a slider or a knob.

Furthermore, due to the potential presence of defects such as ventricular septal defects and atrial septal defects, consideration must be given to the concurrent editing of corresponding structures. Taking ventricular editing as an example, if a ventricular septal defect exists, the structure of the defect must be edited concurrently to ensure that the defect area fits seamlessly between the two ventricles.

### (9) Editing of Aortic Valve Size

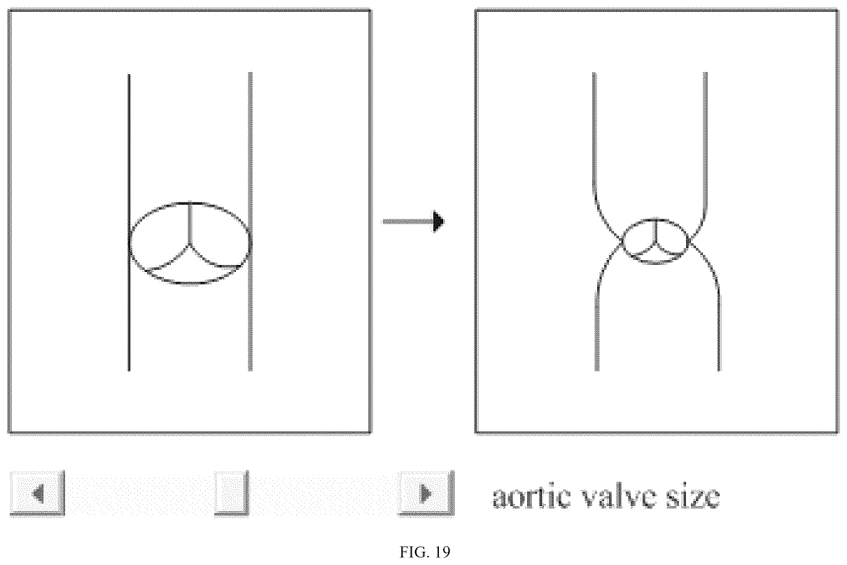

Aortic valve editing is primarily used to modify the size of the pulmonary valve and aortic valve. FIG. 19 illustrates an example of editing aortic valve, which may include the following steps:
Determining the aortic valve (e.g., aortic valve or pulmonary valve) to be edited, for instance, by clicking on it for selection;
Enlarging or shrinking the selected valve based on an operation instruction from a size editing control (such as a slider control or a knob control).

One possible implementation algorithm involves calculating the center of the elliptical aortic valve and scaling the entire valve up or down from this center to achieve a desired size change.

Furthermore, the aortic valve, as a sub-anatomical model, is typically connected to a major artery above (the aortic valve connects to the aorta, and the pulmonary valve connects to the pulmonary artery). Below, it may be connected to an arterial cone. When changing the size of the aortic valve, it is essential to consider the concurrent editing of connected vessels to ensure the connectivity between different structures. The concurrent editing of related structures begins by altering the connection points with the aortic valve. Subsequently, to ensure a smooth transition between the connection points and the overall vessel, it is necessary to re-interpolate and generate the linked structure at regular intervals. Spline interpolation can be used as one of the interpolation methods.

### (10) Editing of the Mitral and Tricuspid Valve Opening Sizes and Thicknesses

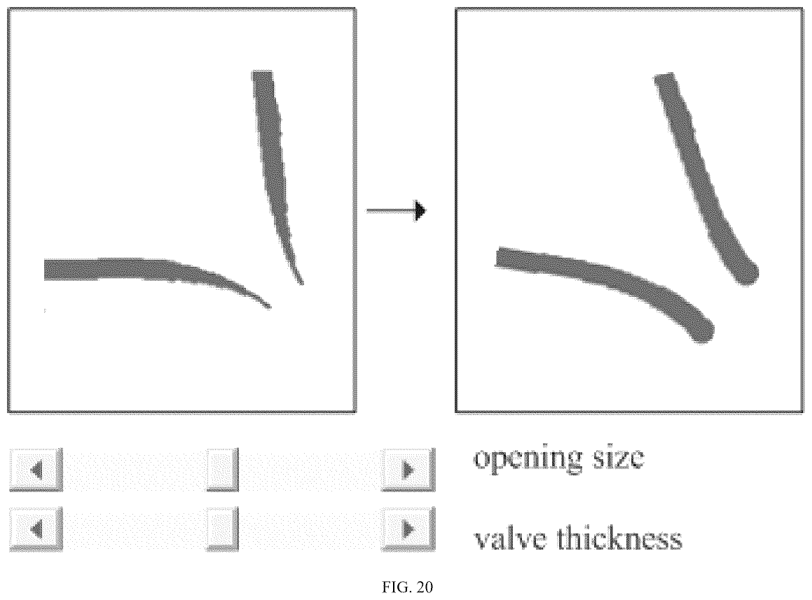

The editing of the mitral and tricuspid valves primarily involves adjusting their opening sizes and thicknesses. FIG. 20 illustrates an example of mitral and tricuspid valve editing, which primarily includes the following steps:
Determining the mitral or tricuspid valve to be edited, for instance, by clicking on it for selection;
Increasing or decreasing the size of the opening of the selected mitral or tricuspid valve based on an operation instruction from an opening size editing control (such as a slider control or a knob control).
Increasing or decreasing the thickness of the selected mitral or tricuspid valve based on an operation instruction from a valve thickness editing control (such as a slider control or a knob control).

It shall be understood that adjusting the opening size primarily modifies the distance between the valve cusps, effectively indicating whether the valve is stenotic. Additionally, altering the valve thickness changes the thickness of the valve cusps, simulating the thickening of the mitral and tricuspid valves. The opening size is determined by calculating the distance between the valve cusps; a greater distance indicates a larger opening. The editing process may involve using the line connecting the two valve cusps as the editing direction, allowing for a comprehensive adjustment of the opening size through holistic editing.

### (11) Editing of Arterial Cone Thickness

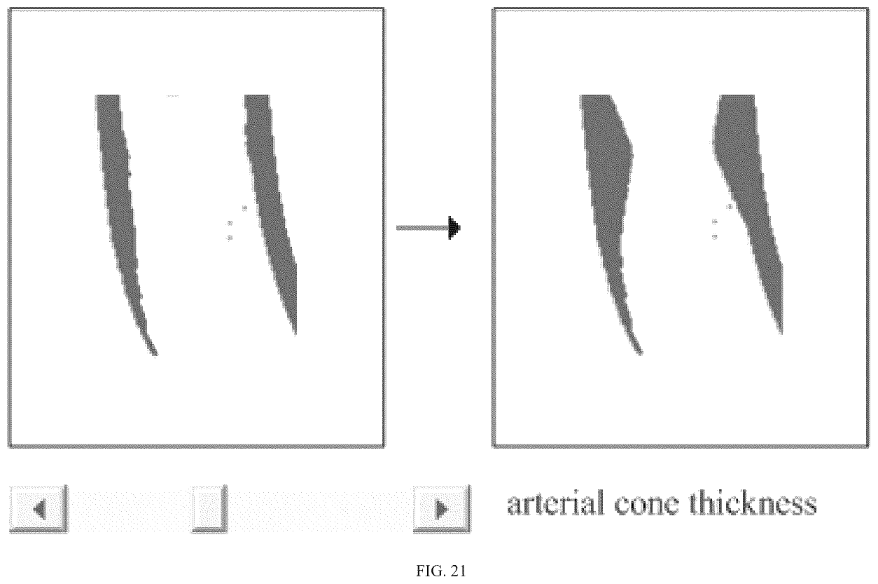

The editing of arterial cone is primarily used to adjust the local thickness of the arterial cone, thereby simulating muscular stenosis at the lower segment of the arterial valve. FIG. 21 illustrates an example of editing an arterial cone, which mainly involves the following steps:
Determining the arterial cone to be edited, for instance, by clicking on it for selection;
Increasing or decreasing the thickness of the arterial cone based on an operation instruction from an arterial cone thickness editing control (such as a slider control or a knob control). One specific process might involve highlighting the local region around the center of the arterial cone, with the center serving as the point of thickening, to achieve the desired change in thickness.

### (12) Editing of the Superimposing Order of Sub-Anatomical Models

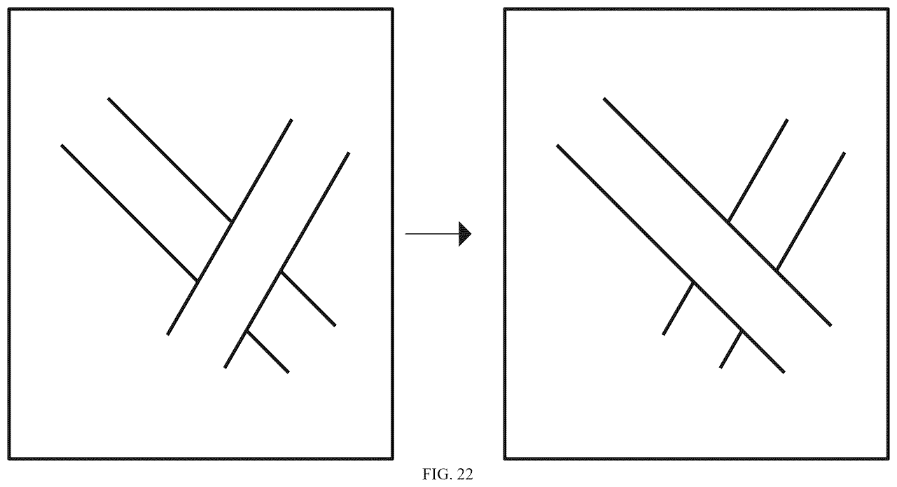

The editing of the superimposing order of sub-anatomical models is used to determine the stacking order of each sub-anatomical model within the lesion model during superimposition. FIG. 22 illustrates an example of editing the superimposing order, wherein the sub-anatomical model whose order is to be modified is selected by a user clicking on it initially, and subsequently, the sub-anatomical model positioned above the initially selected one is clicked on by the user, causing the order of the initially selected structure to be moved above the secondarily clicked structure, thereby achieving a change in the superimposing order of the structures.

### (13) Replacement of Sub-Anatomical Models

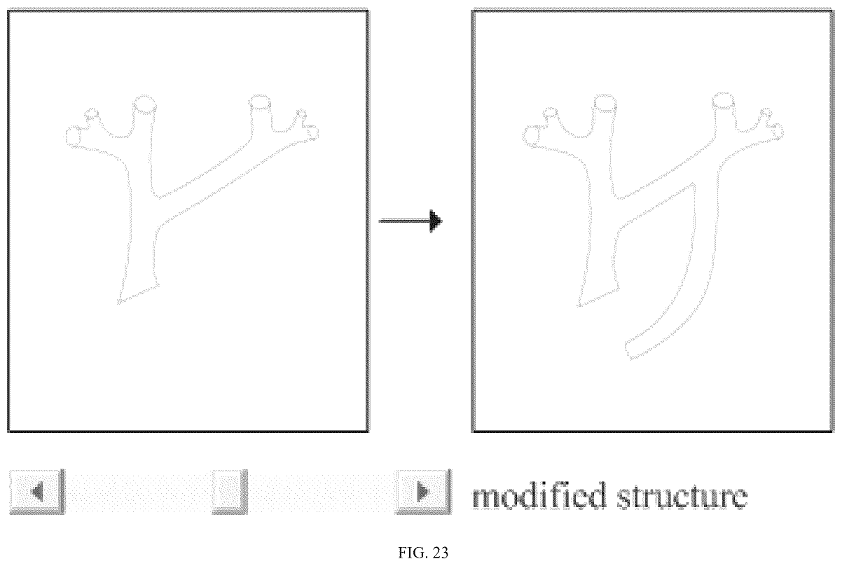

The replacement of sub-anatomical models is used to modify the structure of the lesion model. It allows for the replacement of different morphologies of sub-anatomical models within the same category, which can be utilized to combine complex malformations. FIG. 23 illustrates an example of the replacement of sub-anatomical models, wherein, the sub-anatomical model to be replaced is selected first, and subsequently, other sub-anatomical models to replace the selected one are chosen through means such as a drop-down control.

### (14) Deletion of Sub-Anatomical Models

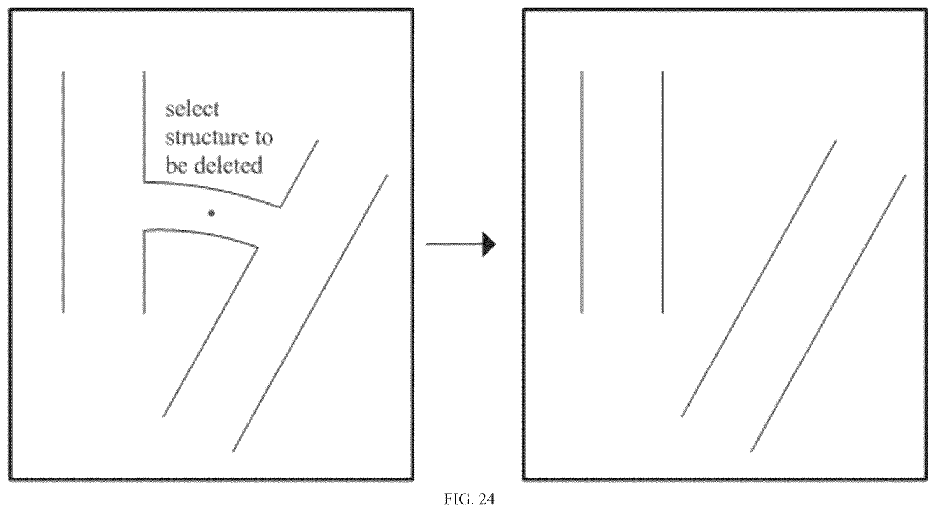

The deletion of sub-anatomical models allows for the removal of any sub-anatomical model within the lesion model, including but not limited to atria, ventricles, blood vessels, tumors, etc. FIG. 24 illustrates an example of the deletion of sub-anatomical models. The process of deletion begins by selecting the sub-anatomical model to be deleted, and subsequently, the selected sub-anatomic model structure is deleted in response to a user's deletion command.

The above provides some explanations regarding the editing of lesion models or, more specifically, sub-anatomical models.

In some embodiments, in response to an editing command for the displayed disease model, one or more sub-anatomical models of the disease model are edited. Additionally, based on the sub-anatomical model to be edited and its editing content, it is determined whether there are any other interdependent sub-anatomical models that require concurrent editing. If such interdependent structures are identified, their editing content is determined based on the original editing content, and they are then edited accordingly. For instance, during the editing of the overall diameter of a blood vessel, changes may propagate to both sides of the vessel, potentially necessitating the concurrent editing of connected sub-anatomical structures such as adjacent blood vessels, aortic valves, and aortic cones.

In some embodiments, based on an editing command for the displayed disease model, the sub-anatomical model to be edited and its editing content are determined. The corresponding content editing of the sub-anatomical model is performed based on the determined structure and its editing content. Furthermore, the type of editing is determined based on the sub-anatomical model to be edited and its editing content, with the types including non-associative editing and associative editing. Non-associative editing refers to the editing of a sub-anatomical model that does not affect other structures, requiring no adaptive updates or editing of those other structures. In contrast, associative editing involves the editing of a sub-anatomical model that impacts and necessitates adaptive updates or editing of other related structures. Therefore, when the editing type is associative, the other interdependent sub-anatomical models and their linked editing content are determined based on the sub-anatomical model being edited and its editing content. These structures are then edited accordingly. For instance, during the editing process of the overall thickness of a blood vessel, changes may occur on both sides of the vessel, potentially necessitating the concurrent editing of connected sub-anatomical structures such as adjacent blood vessels, aortic valves, and aortic cones.

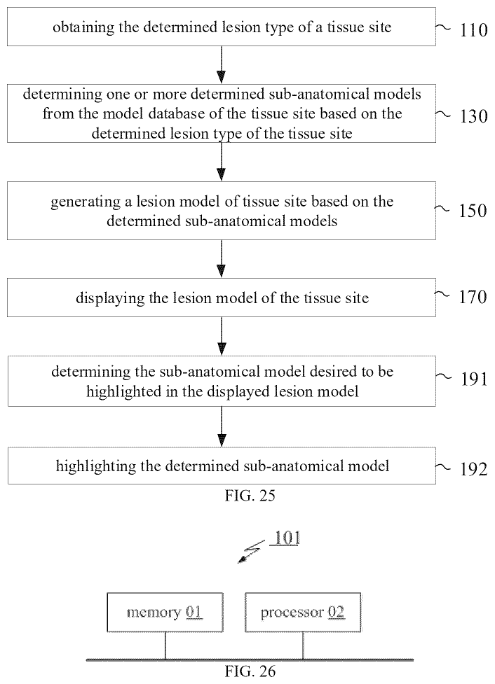

Referring to FIG. 25, the method for generating a lesion model of a tissue site in some embodiments may further include step 191: determining the sub-anatomical models that need to be highlighted in the displayed lesion model, and step 192: highlighting the determined sub-anatomical models.

Structure highlighting can be applied to any one or more sub-anatomical models in the lesion model.

Refer to FIG. 26, an apparatus for generating a lesion model of a tissue site disclosed in some embodiments may include a memory 01 and a processor 02. The memory 01 is configured to store programs, while the processor 02 is configured to execute the programs stored in the memory 01 to implement the method described in any of the embodiments presented herein. For instance, the processor 02 obtains the determined lesion type of the tissue site and, based on this determined lesion type of the tissue site, determines one or more determined sub-anatomical models from the model database of the tissue site. Specifically, based on the determined lesion type of the tissue site, the processor 02 determines one or more determined sub-anatomical models associated with the determined lesion type from the model database of the tissue site. Subsequently, the processor 02 generates a lesion model of the determined lesion type, based on the determined plurality of determined sub-anatomical models. This is accomplished, for example, by superimposing the determined plurality of determined sub-anatomical models in a predetermined order to generate the lesion model, which is then intended for display.

In the embodiments above, in the generated lesion model, the plurality of sub-anatomical models for generating the lesion model may be located on different layers. For example, at least two of them are located on different layers. This allows the sub-anatomical models located on different layers to be easily adjusted without affecting with each other.

In one embodiment (not shown), a method for generating a lesion model of a tissue site is provided. The method may include the following steps.

First, a user interface may be provided, which may include a control pointing to the lesion model generation mode. Here, the user interface may be a software interface displayed on a display device or a physical hardware interface, such as a control panel. Here, the “control” may be a software control, such as an option in a menu, a soft key button, etc., or a hardware control, such as a physical button, a voice control device, a gesture control device, etc. Here, the control “pointing to” the lesion model generation mode means that the control is associated with the lesion model generation mode, and through the control, the lesion model generation mode can be controlled, such as starting or stopping the lesion model generation mode.

The lesion model generation device can receive operations to the control in the user interface and, in response to these operations, enter the lesion model generation mode. Here, the operation to the control in the user interface may be a user operation, an operation by the lesion model generation device, or a remote operation to the control of the lesion model generation device via other devices. The operation may be various suitable types of operation, such as an user click, an user voice input, an user gesture, an instruction from the lesion model generation device or other devices, etc.

Entering the lesion model generation mode may mean that the lesion model generation device enters a state capable of generating lesion models. However, it does not necessarily mean that the state of the lesion model generation device or the user interface must undergo a complete change or switch. For example, it can start a corresponding subroutine or start a corresponding user interface for generating the lesion model based on the original working state or the original user interface thereof, as long as the lesion model generation device can perform the lesion model generation function accordingly.

In one embodiment, in this lesion model generation mode, the lesion model generation device may display a lesion type selection interface for a tissue site. The lesion type selection interface may include one or more lesion types, and in response to an operation performed on the lesion type selection interface, a determined lesion type of the tissue site may be determined from the one or more lesion types in the lesion type selection interface. Subsequently, based on the determined lesion type, a lesion model of the tissue site corresponding to the determined lesion type may be generated, and be displayed.

In one embodiment, the process of determining the determined lesion type from the lesion type selection interface may include first determining the total lesion type, and then determining the sub-lesion type based on the total lesion type. The sub-lesion type may be the determined lesion type.

For example, referring to FIG. 5(a), the lesion model generation device may display a lesion type selection interface for a tissue site, receive a first selection operation performed on the lesion type selection interface, and in response to the first selection operation performed on the lesion type selection interface, determine a determined total lesion type from the one or more total lesion types in the lesion type selection interface. Based on the determined total lesion type, one or more sub-lesion types associated with the determined total lesion type may be displayed, where the one or more sub-lesion types associated with the determined total lesion type are sub-lesion types belonging to the determined total target lesion type. Subsequently, a second selection operation to the displayed one or more sub-lesion types may be received, and in response to the second selection operation, a determined lesion type may be determined from the displayed one or more sub-lesion types. Subsequently, based on the determined lesion type, a lesion model of the tissue site corresponding to the determined lesion type may be generated, and be displayed.

In the embodiments above, the lesion type selection interface for the tissue site may be displayed in various suitable ways, such as through text, graphics, lists, etc. The aforementioned first and second operations, as well as the operations performed on the lesion type selection interface, may be various types of operations, such as an user click, an user drag, an user voice input, an user gesture, an instruction from the lesion model generation device or other devices, etc.

In some cases, the tissue site (e.g., fetal heart or adult heart) have numerous lesion types, and each lesion type may have multiple sub-lesion types. In such situations, displaying all possible lesion types for selection requires occupying a very large display area within the limited display space of the device, making it impossible to display other necessary information, making the displayed words to be very small which causes that it is difficult for the user to read, or making it to be divided into multiple pages, requiring the user to flip through many pages to find the desired lesion type, which is inconvenient for the user and reduces their work efficiency. In the embodiments above, by first displaying the total lesion types, and after determining the total lesion type, displaying and determining the sub-lesion types, the number of candidate lesion types that desired to be displayed simultaneously can be effectively reduced, thus making the operation more convenient for the user.

In one embodiment, the process of determining the determined lesion type of the tissue site from one or more lesion types in the lesion type selection interface in response to an operation on the lesion type selection interface and generating a lesion model of the tissue site based on the determined lesion type may include the combination of lesion models of two or more determined lesion types. For example, in this embodiment, the process may include: receiving a first selection instruction for selecting a first determined lesion type on the lesion type selection interface; determining the first determined lesion type according to the received first selection instruction; determining a first lesion model according to the first determined lesion type; receiving a second selection instruction for selecting a second determined lesion type on the lesion type selection interface; determining the second determined lesion type according to the received second selection instruction; and determining a second lesion model according to the second determined lesion type. Subsequently, the first lesion model and the second lesion model may be combined to obtain the lesion model of the tissue site. This allows the users to generate their desired lesion models more conveniently and flexibly.

In the embodiments above, the generated lesion model may include a plurality of determined sub-anatomical models, where at least two of the plurality of sub-anatomical models in the lesion model are located in different layers of the lesion model.

In the embodiments above, it is also possible to determine which sub-anatomical models in the displayed lesion model is desired to be highlighted, and to highlight the determined sub-anatomical model.

In one embodiment, the operation of adding a sub-anatomical model may be performed on the generated lesion model. In this embodiment, the position for new sub-anatomical model may be determined within the lesion model, and the new sub-anatomical model may be added at that position. Here, the position for the new sub-anatomical model may be determined by receiving user input, or be determined automatically by the lesion model generation device, or be determined according to received remote instructions, etc. The type of the sub-anatomical model to be added may be determined by receiving user input, or be determined automatically by the lesion model generation device, or be determined according to received remote instructions, etc.

For example, in one embodiment, the lesion model may include a vascular model. Referring to FIG. 10 and FIG. 11, in this embodiment, the operation of adding a vascular branch model or adding a bridging vascular model can be performed on the vascular model. In this embodiment, a first position may be determined at the vascular model in the lesion model, and according to the determined first position, a vascular branch model may be added at the first position in the lesion model. Alternatively, a first position may be determined at the vascular model of the lesion model, and a second position may be determined at the vascular model of the lesion model. According to the determined first position and the determined second position, a bridging vascular model connecting the first position and second position may be added to the lesion model. Here, the first position and the second position may be determined by receiving and responding to user input, or be determined automatically by the lesion model generation device, or be determined according to received remote instructions, etc.

In one embodiment, the lesion model may include a fetal heart model or a heart model. Referring to FIG. 12, in this embodiment, an operation to add a defect model can be performed in the fetal heart model or the heart model. In this embodiment, a position for defect may be determined in the fetal heart model or the heart model of the lesion model, and a defect model may be added at the position for defect in the lesion model. The defect model may be a ventricular septal defect model, an atrial septal defect model, and/or an atrioventricular septal defect model, etc. Here, the position for defect may be determined by receiving and responding to an user input, or be determined automatically by the lesion model generation device, or be determined according to received remote instructions, etc.

In one embodiment, the added sub-anatomical model may be a tumor model. Referring to FIG. 13, in this embodiment, the position for tumor may be determined in the lesion model, and a tumor model may be added at the position for tumor in the lesion model. Here, the position for tumor may be determined by receiving and responding to an user input, or be determined automatically by the lesion model generation device, or be determined according to received remote instructions, etc.

In one embodiment, various adjustment operations may be performed on the sub-anatomical model in the generated lesion model. Referring to FIGS. 14 to 24, in this embodiment, a selection instruction for selecting a sub-anatomical model in the lesion model may be received. According to the received selection instruction, the selected sub-anatomical model to be adjusted may be determined in the lesion model. Then, an adjustment instruction may be received, and according to the adjustment instruction, the position, shape, size, orientation, and/or thickness of the selected sub-anatomical model may be adjusted. Here, the received selection instruction or adjustment instruction may be input by the user, automatically generated by the lesion model generation device, or received from other remote devices.

For example, in one embodiment, the lesion model may include a vascular model. In this embodiment, a selection instruction for selecting a vascular model in the lesion model may be received, and a selected vascular model may be determined in the lesion model according to the received selection instruction. Then, an adjustment instruction may be received, and the position, the orientation, the diameter and/or the radius of the selected vascular model, etc., may be adjusted according to the adjustment instruction.

In one embodiment, the lesion model includes a defect model. In this embodiment, a selection instruction for selecting a defect model in the lesion model may be received, and a selected defect model may be determined in the lesion model according to the received selection instruction. Then, an adjustment instruction may be received, and the position and/or the size of the selected defect model, etc., may be adjusted according to the adjustment instruction.

In one embodiment, the lesion model includes a tumor model. In this embodiment, a selection instruction for selecting a tumor model in the lesion model can be received, and a selected tumor model is determined in the lesion model according to the received selection instruction. Then, an adjustment instruction is received, and the position, the size, and/or the orientation of the selected tumor model are adjusted according to the adjustment instruction.

In one embodiment, the lesion model may include an atrial model, a ventricular model, or a myocardial model. In this embodiment, a selection instruction for selecting an atrial model, a ventricular model, or a myocardial model in the lesion model can be received, and a selected atrial model, a selected ventricular model, or a selected myocardial model is determined in the lesion model according to the received selection instruction. Then, an adjustment instruction is received, and the size and/or the position of the selected atrial model or the selected ventricular model, or the position and/or the thickness of the selected myocardial model, etc., are adjusted according to the adjustment instruction.

In this embodiment, the position and/or the size of a defect model associated with the selected atrial model, the selected ventricular model or the selected myocardial model may also be automatically adjusted based on the adjustment to the selected atrial model, the selected ventricular model or the selected myocardial model, such that the adjusted defect model matches the adjusted selected atrial model, the adjusted selected ventricular model or the adjusted selected myocardial model.

In one embodiment, the lesion model may include an aortic valve model. In this embodiment, a selection instruction for selecting an aortic valve model in the lesion model can be received, and a selected aortic valve model can be determined in the lesion model according to the received selection instruction. Then, an adjustment instruction may be received, and the position and/or the size, etc. of the selected aortic valve model may be adjusted according to the adjustment instruction.

In this embodiment, the position and/or the size of the vascular model associated with the selected aortic valve model can also be automatically adjusted based on the adjustment to the selected aortic valve model, such that the adjusted vascular model matches the adjusted selected aortic valve model.

In one embodiment, the lesion model may include a mitral valve model or a tricuspid valve model. In this embodiment, a selection instruction for selecting a mitral valve model or a tricuspid valve model can be received, and a selected mitral valve model or a selected tricuspid valve model may be determined in the lesion model according to the received selection instruction. Then, an adjustment instruction may be received, and the position, the size of opening and/or the valve thickness, etc., of the selected mitral valve model or the selected tricuspid valve model may be adjusted according to the adjustment instruction.

Similarly, the generated lesion model may be further modified by operations such as adding, deleting, editing or adjusting, etc., making it easier and more flexible for the user to generate the lesion model they desire. This allows the doctor, the patient or other user to visually view the lesion condition of the tissue site, thus helping them to more easily understand the lesion condition of the target area.

In some embodiments, the processor 02 includes but is not limited to devices such as a central processing unit (CPU), micro controller unit (MCU), field programmable gate array (FPGA), and digital signal processing (DSP) used to interpret computer instructions and process data in computer software.

In some embodiments, the ultrasound imaging system 100 described herein may also be utilized to execute and implement the methods outlined in any of the embodiments presented. For instance, the processor 30 is tasked with executing the methods detailed in any of these embodiments. In some examples, the processor 30 obtains the determined lesion type of the tissue site and, based on this determined lesion type of the tissue site, determines one or more determined sub-anatomical models from the model database of the tissue site. Specifically, based on the determined lesion type of the tissue site, it determines one or more determined sub-anatomical models associated with the determined lesion type from the model database of the tissue site. Subsequently, based on the determined plurality of determined sub-anatomical models, the processor 30 generates lesion model of the tissue site. This is often achieved by superimposing the plurality of determined sub-anatomical models in a predetermined order to generate the lesion model, which is then displayed on the monitor 40 under the control of the processor 30.

In some examples as disclosed herein, the method and apparatus for generating a lesion model of a tissue site have created a novel communication bridge between doctors (such as ultrasound specialists and clinical physicians) and patients, significantly enhancing the accuracy of disease description, particularly in cases like congenital heart disease.

This disclosure describes, with reference to various exemplary embodiments. However, Those skilled in the art will recognize that modifications and changes may be made to the exemplary embodiments without departing from the scope of this document. For instance, various operational steps, as well as the components used to execute these steps, may be implemented in different manners, taking into account specific applications or various cost functions related to system operation (e.g., one or more steps may be omitted, modified, or combined with other steps).

In the aforementioned embodiments, the implementation may be achieved, in whole or in part, through software, hardware, firmware, or any combination thereof. Additionally, as understood by those skilled in the art, the principles presented herein may be embodied in a computer program product reflected on a computer-readable storage medium, wherein the readable storage medium is pre-installed with computer-readable program code. Any tangible, non-transitory computer-readable storage medium may be utilized, including magnetic storage devices (hard disks, floppy disks, etc.), optical storage devices (CD-ROMs, DVDs, Blu-ray discs, etc.), flash memory, and/or the like. These computer program instructions can be loaded onto general-purpose computers, special-purpose computers, or other programmable data processing devices to form a machine, enabling the instructions executed on these computers or other programmable data processing devices to generate devices that perform specified functions. These computer program instructions can also be stored in a computer-readable memory, which can instruct a computer or other programmable data processing device to operate in a specific manner, such that the instructions stored in the computer-readable memory can form an article of manufacture, including an implementation device that realizes the specified functions. Furthermore, computer program instructions can be loaded onto a computer or other programmable data processing device, thereby executing a series of operational steps on the computer or other programmable device to produce a computer-implemented process. This allows the instructions executed on the computer or other programmable device to provide steps for realizing specified functions.

Although the principles herein have been shown in various embodiments, many modifications to structures, arrangements, proportions, elements, materials, and components that are particularly suited to specific environmental and operational requirements may be used without departing from the principles and scope of the present disclosure. The aforementioned modifications, as well as other alterations or corrections, will be included within the scope of the present disclosure.

The aforementioned detailed descriptions have been presented with reference to various embodiments. However, those skilled in the art will recognize that various modifications and changes can be made without departing from the scope of this disclosure. Therefore, the consideration of this disclosure is to be in an illustrative rather than a restrictive sense, and all such modifications are to be included within its scope. Similarly, the advantages, other benefits, and solutions to problems related to various embodiments have been described above. However, the benefits, advantages, solutions to problems, and any elements that may produce these, or make them more explicit, should not be interpreted as critical, required, or essential. The term “including” and any other variants used in this document are non-exclusive inclusions, such that processes, methods, articles, or devices that include lists of elements not only include those elements but also other elements not explicitly listed or belonging to the process, method, system, article, or device. Furthermore, the term “coupled” and any other variants used in this document refer to physical, electrical, magnetic, optical, communication, functional, and/or any other type of connection.

Those skilled in the art will recognize that numerous changes can be made to the details of the foregoing embodiments without departing from the fundamental principles of this invention. Therefore, the scope of this invention should be determined solely by the claims.

What is claimed is:

1. A method for generating a lesion model of a tissue site, comprising:
providing a user interface, wherein the user interface comprises a control pointing to a lesion model generation mode;
receiving an operation to the control on the user interface; and
in response to the operation to the control on the user interface, entering a lesion model generation mode;
wherein, in the lesion model generation mode:
displaying a lesion type selection interface for the tissue site, wherein the lesion type selection interface comprises one or more lesion types;
in response to an operation on the lesion type selection interface, determining a determined lesion type of the tissue site from the one or more lesion types in the lesion type selection interface;
generating a lesion model of the tissue site based on the determined lesion type; and
displaying the lesion model of the tissue site.

2. The method of claim 1, wherein the generated lesion model comprises a plurality of sub-anatomical models, wherein at least two of the plurality of sub-anatomical models of the lesion model are located in different layers of the lesion model.

3. The method of claim 2, further comprising:
determining a sub-anatomical model desired to be highlighted in the displayed lesion model; and
highlighting the determined sub-anatomical model.

4. The method of claim 1, further comprising: editing the lesion model in response to an editing command to the displayed lesion model.

5. The method of claim 1, wherein, the lesion model comprises a vascular model, and the method further comprises:
determining a first position at the vascular model of the lesion model;
according to the determined first position, adding a vascular branch model at the first position in the lesion model;
or,
determining a first position at the vascular model of the lesion model;
determining a second position at the vascular model of the lesion model; and
according to the determined first position and the determined second position, adding a bridging vascular model connecting the first position and the second position to the lesion model.

6. The method of claim 1, wherein: the lesion model comprises a fetal heart model or a heart model, and the method further comprises:
determining a position for defect in the fetal heart model or the heart model of the lesion model; and
adding a ventricular septal defect model, an atrial septal defect model and/or an atrioventricular septal defect model at the position for defect in the lesion model.

7. The method of claim 1, further comprising:
determining a position for tumor in the lesion model; and
adding a tumor model at the position for tumor in the lesion model.

8. The method of claim 1, wherein: the lesion model comprises a vascular model, and the method further comprises:
receiving a selection instruction for selecting a vascular model in the lesion model;
determining a selected vascular model in the lesion model according to the received selection instruction;
receiving an adjustment instruction; and
adjusting a position, an orientation, a diameter and/or a radius of the selected vascular model according to the adjustment instruction.

9. The method of a claim 1, wherein: the lesion model comprises a defect model, and the method further comprises:
receiving a selection instruction for selecting a defect model in the lesion model;
determining a selected defect model in the lesion model according to the received selection instruction;
receiving an adjustment instruction; and
adjusting a position and/or a size of the selected defect model according to the adjustment instruction.

10. The method of claim 1, wherein: the lesion model comprises a tumor model, and the method further comprises:
receiving a selection instruction for selecting a tumor model in the lesion model;
determining a selected tumor model in the lesion model according to the received selection instruction;
receiving an adjustment instruction; and
adjusting a position, a size and/or an orientation of the selected tumor model according to the adjustment instruction.

11. The method of claim 1, wherein: the lesion model comprises an atrial model, a ventricular model or a myocardial model, and the method further comprises:
receiving a selection instruction for selecting an atrial model, a ventricular model or a myocardial model in the lesion model;
determining a selected atrial model, a selected ventricular model or a selected myocardial model in the lesion model according to the received selection instruction;
receiving an adjustment instruction; and
adjusting a size and/or a position of the selected atrial model or the selected ventricular model, or adjusting a position and/or a thickness of the selected myocardial model according to the adjustment instruction.

12. The method of claim 11, further comprising:
automatically adjusting a position and/or a size of a defect model associated with the selected atrial model, the selected ventricular model or the selected myocardial model according to the adjustment to the selected atrial model, the selected ventricular model or the selected myocardial model, such that the adjusted defect model matches the adjusted selected atrial model, the adjusted selected ventricular model or the adjusted selected myocardial model.

13. The method of claim 1, wherein: the lesion model comprises an aortic valve model, and the method further comprises:
receiving a selection instruction for selecting an aortic valve model in the lesion model;
determining a selected aortic valve model in the lesion model according to the received selection instruction;
receiving an adjustment instruction; and
adjusting a position and/or a size of the selected aortic valve model according to the adjustment instruction.

14. The method of claim 13, further comprising:
automatically adjusting a position and/or a size of a vascular model associated with the selected aortic valve model according to the adjustment to the selected aortic valve model, such that the adjusted vascular model matches the adjusted selected aortic valve model.

15. The method of claim 1, wherein: the lesion model comprises a mitral valve model or a tricuspid valve model, and the method further comprises:
receiving a selection instruction for selecting a mitral valve model or a tricuspid valve model in the lesion model;
determining a selected mitral valve model or a selected tricuspid valve model in the lesion model according to the received selection instruction;
receiving an adjustment instruction; and
adjusting a position, a size of opening and/or a valve thickness of the selected mitral valve model or the selected tricuspid valve model according to the adjustment instruction.

16. The method of claim 1, further comprising:
receiving a selection instruction for selecting a sub-anatomical model in the lesion model;
determining a selected sub-anatomical model in the lesion model according to the received selection instruction;
receiving an adjustment instruction; and
adjusting a position, a shape, a size, an orientation and/or a thickness of the selected sub-anatomical model according to the adjustment instruction.

17. The method of claim 1, wherein, in response to an operation on the lesion type selection interface, determining a determined lesion type of the tissue site from the one or more lesion types in the lesion type selection interface and generating a lesion model of the tissue site based on the determined lesion type comprising:
receiving a first selection instruction for selecting a first determined lesion type on the lesion type selection interface;
determining the first determined lesion type according to the received first selection instruction;
determining a first lesion model according to the first determined lesion type;
receiving a second selection instruction for selecting a second determined lesion type on the lesion type selection interface;
determining the second determined lesion type according to the received second selection instruction;
determining a second lesion model according to the second determined lesion type; and
obtaining the lesion model of the tissue site according to the first lesion model and the second lesion model.

18. The method of claim 1, further comprising:
determining a position for new sub-anatomical model in the lesion model; and
adding a new sub-anatomical model at the determined position for new sub-anatomical model.

19. An apparatus for generating a lesion model of a tissue site, comprising:
a memory configured to store a program; and
a processor configured to execute the program stored in the memory to:
provide a user interface, wherein the user interface comprises a control pointing to a lesion model generation mode;
receive an operation to the control on the user interface; and
in response to the operation to the control on the user interface, enter a lesion model generation mode;
wherein, in the lesion model generation mode:
display a lesion type selection interface for the tissue site, wherein the lesion type selection interface comprises one or more lesion types;
in response to an operation on the lesion type selection interface, determine a determined lesion type of the tissue site from the one or more lesion types in the lesion type selection interface;
generate a lesion model of the tissue site based on the determined lesion type; and
display the lesion model of the tissue site.

20. A computer-readable storage medium comprising a program, wherein the program is executable by a processor to:
provide a user interface, wherein the user interface comprises a control pointing to a lesion model generation mode;
receive an operation to the control on the user interface; and
in response to the operation to the control on the user interface, enter a lesion model generation mode;
wherein, in the lesion model generation mode:
display a lesion type selection interface for the tissue site, wherein the lesion type selection interface comprises one or more lesion types;
in response to an operation on the lesion type selection interface, determine a determined lesion type of the tissue site from the one or more lesion types in the lesion type selection interface;
generate a lesion model of the tissue site based on the determined lesion type; and
display the lesion model of the tissue site.
